(19) United States
(12) Patent Application Publication
(10) Pub. No.: US 2021/0132266 A1
(43) Pub. Date: May 6, 2021

(54) FLUID LENS WITH REDUCED BUBBLE FORMATION

(71) Applicant: Facebook Technologies, LLC, Menlo Park, CA (US)

(72) Inventors: Andrew John Ouderkirk, Kirkland, WA (US); Hayden Erik Hernández, Oxfordshire (GB); Thomas Norman Llyn Jacoby, Oxford (GB)

(21) Appl. No.: 17/075,036

(22) Filed: Oct. 20, 2020

Related U.S. Application Data
(60) Provisional application No. 62/930,790, filed on Nov. 5, 2019.

(51) Int. Cl. G02B 3/14; G02B 1/04; G02B 27/01

(52) U.S. Cl. CPC G02B 3/14; G02B 1/10; G02B 27/0172; G02B 1/04

(57) ABSTRACT

Disclosed devices may include a fluid lens that includes a membrane, optionally a substrate, and a fluid located within an enclosure that may be at least partially defined by the substrate and the membrane. A coating may be disposed on at least a portion of the interior surface of the enclosure. The coating may have a coating surface in contact with the fluid. The coating may significantly reduce bubble formation within the fluid (e.g., compared with an uncoated surface). Example devices include adjustable fluid lenses that may be adjusted to a plano-concave configuration. Various other methods, systems, and computer-readable media are also disclosed.

### CROSS REFERENCE TO RELATED APPLICATION

This application claims the benefit of U.S. Provisional Application No. 62/930,790, filed Nov. 5, 2019, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIGS. 1A-1C illustrate example fluid lenses.

FIGS. 2A-2G illustrate example fluid lenses, and adjustment of the optical power of the fluid lenses.

FIG. 3 illustrates an example ophthalmic device.

FIGS. 4A-4B illustrate a fluid lens having a membrane assembly including a support ring.

FIG. 5 illustrates deformation of a non-circular fluid lens.

FIGS. 6A-6C illustrate a fluid lens having a concave configuration.

FIGS. 7A-7C illustrate bubble formation in a fluid lens.

FIG. 7D illustrates avoidance of bubble formation using an interior coating, according to embodiments of this disclosure.

FIGS. 8A-81 illustrate fabrication of a fluid lens having an interior coating, according to embodiments of this disclosure.

FIG. 9 illustrates a method of fabricating a fluid lens having an interior coating, according to embodiments of this disclosure.

FIG. 10 illustrates a method of fabricating a fluid lens having an interior coating, according to embodiments of this disclosure.

FIG. 11 is an illustration of an exemplary artificial-reality headband that may be used in connection with embodiments of this disclosure.

FIG. 12 is an illustration of exemplary augmented-reality glasses that may be used in connection with embodiments of this disclosure.

FIG. 13 is an illustration of an exemplary virtual-reality headset that may be used in connection with embodiments of this disclosure.

FIG. 14 is an illustration of exemplary haptic devices that may be used in connection with embodiments of this disclosure.

FIG. 15 is an illustration of an exemplary virtual-reality environment according to embodiments of this disclosure.

FIG. 16 is an illustration of an exemplary augmented-reality environment according to embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and are described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Formation of bubbles in the lens fluid of a fluid lens may degrade the appearance and the optical performance of the fluid lens. It would be useful to reduce, or substantially eliminate, the formation of bubbles.

The present disclosure is generally directed to fluid lenses, which include liquid lenses, such as adjustable liquid lenses. As is explained in greater detail herein, embodiments of the present disclosure include fluid lenses, membranes used in fluid lenses, membrane assemblies, and improved devices using fluid lenses, such as ophthalmic devices, augmented reality devices, virtual reality devices, and the like.

Adjustable fluid lenses are useful for ophthalmic, virtual reality (VR), and augmented reality (AR) devices. In some example ophthalmic devices, fluid lenses may be used for vision correction, including correction of presbyopia. In some example AR and/or VR devices, fluid lenses may be used for the correction of what is commonly known as the vergence accommodation conflict (VAC). Examples described herein may include such devices, including fluid lenses for the correction of VAC.

Embodiments of the present disclosure include fluid lenses, including a substrate and a membrane, at least in part enclosing a lens enclosure. The lens enclosure may be referred to hereinafter as an “enclosure” for conciseness. The enclosure may receive a lens fluid, and the interior surface of the enclosure may be proximate the lens fluid. In some examples, at least part of the interior surface of the enclosure may have a coating that reduces, or substantially eliminates, formation of bubbles in the lens fluid. The coating may be located between the lens fluid and the interior surface of the enclosure (that may include interior surfaces of the membrane and/or substrate).

Examples disclosed herein may include fluid lenses, membrane assemblies (that may include a membrane and, e.g., a peripheral structure such as a support ring or a peripheral wire), and devices including one or more fluid lenses. Example devices include ophthalmic devices (e.g., spectacles), augmented reality devices, virtual reality devices, and the like. In some examples, a device may include a fluid lens configured as a primary lens of an optical device, for example, as the primary lens for light entering the user's eye.

Features from any of the embodiments described herein may be used in combination with one another in accordance with the general principles described herein. These and other embodiments, features, and advantages will be more fully understood upon reading the detailed description in conjunction with the accompanying drawings and claims.

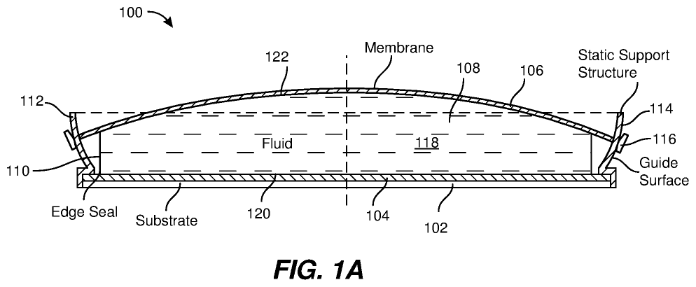

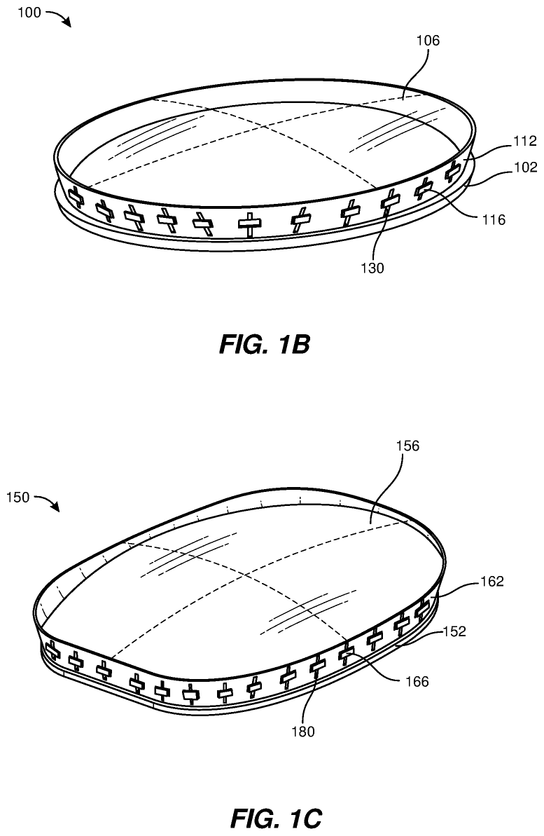

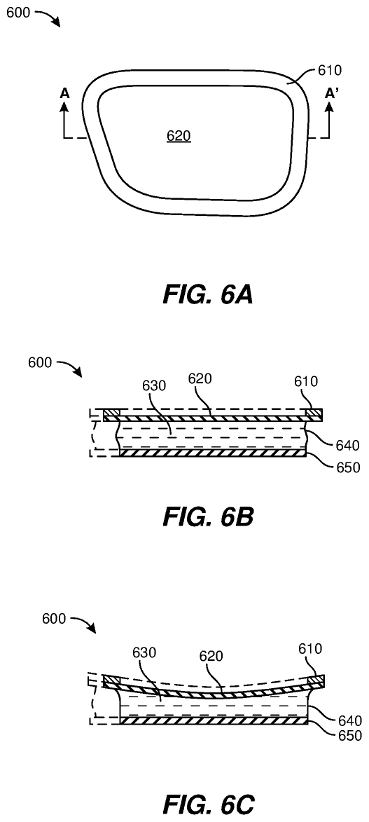

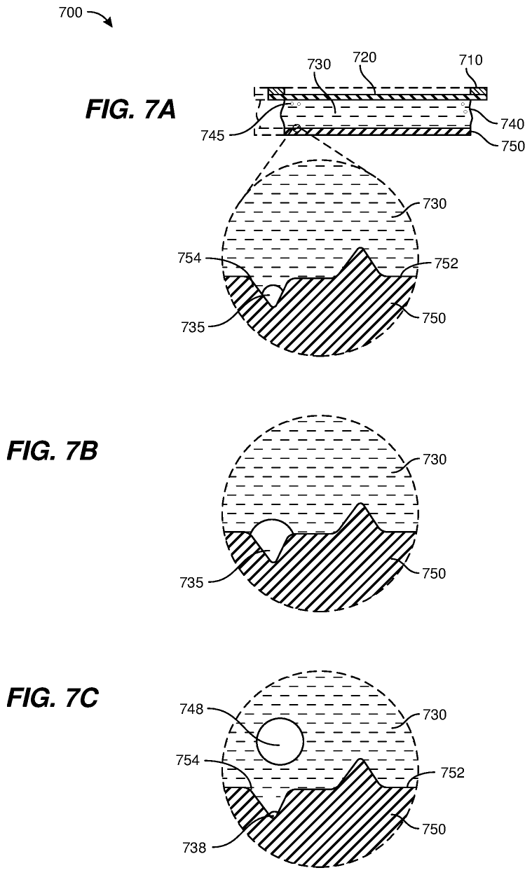

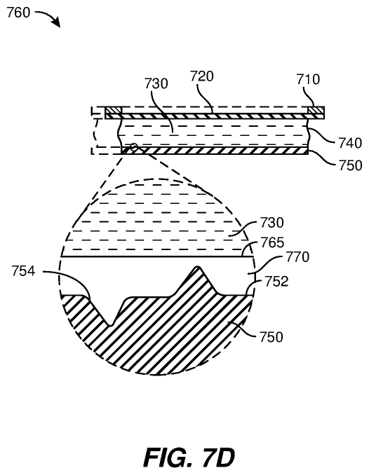

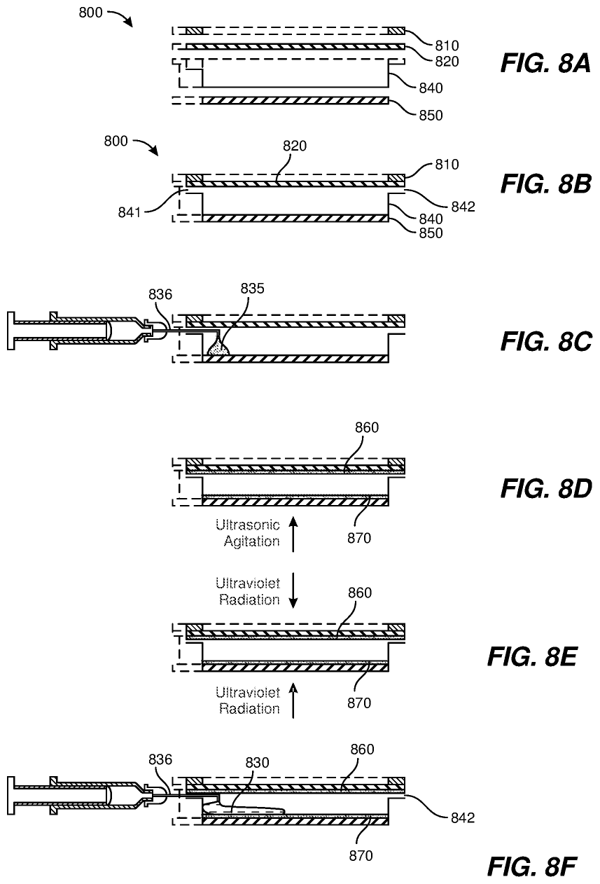

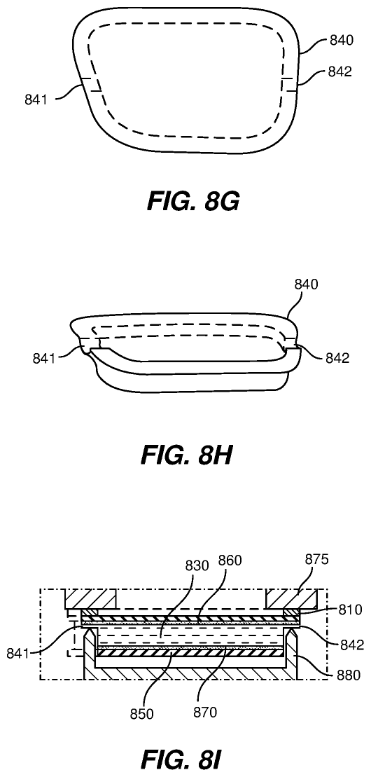

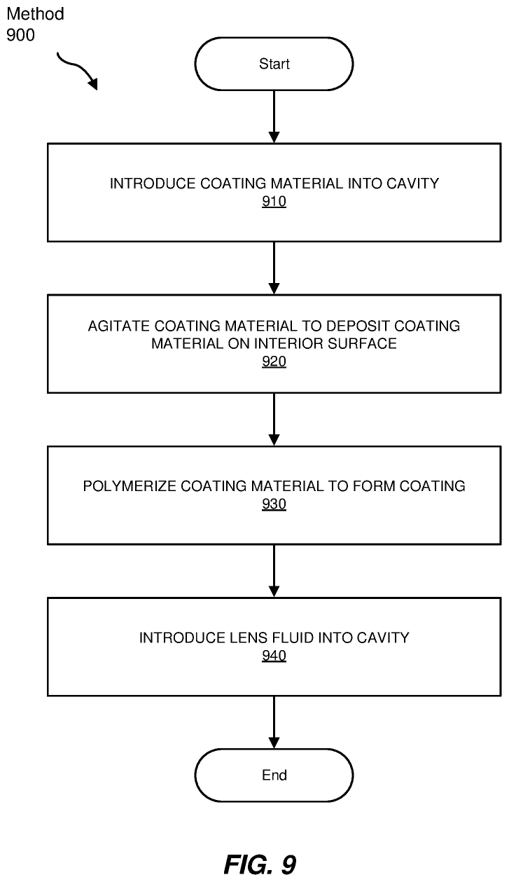

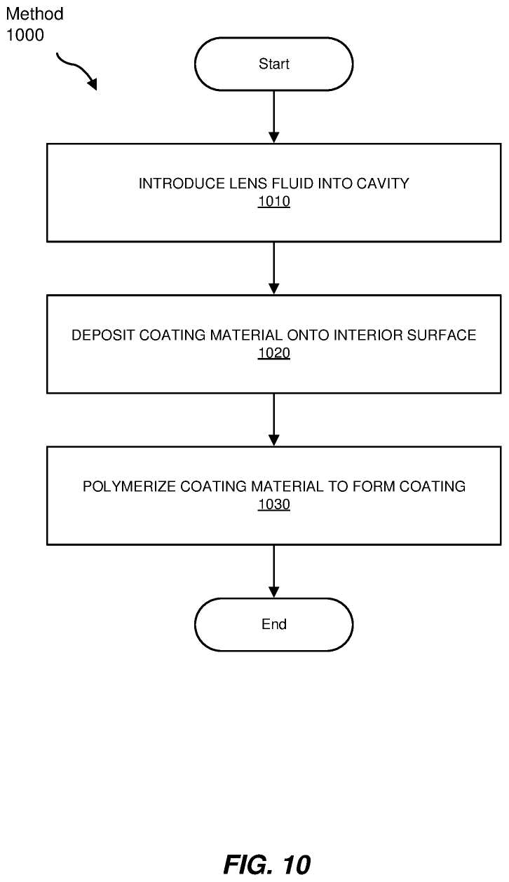

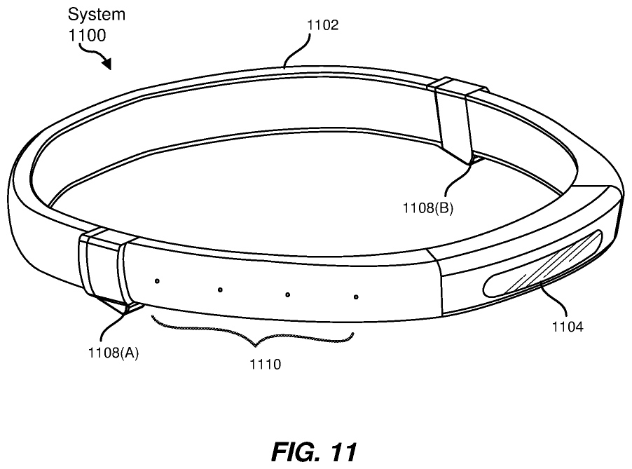

The following provides, with reference to FIGS. 1-16, detailed descriptions of fluid lenses, including fluid lenses having a reduced propensity for bubble formation. FIGS. 1-5 illustrate example fluid lenses. FIGS. 6A-6C show the configuration of an example plano-concave fluid lens. FIGS. 7A-7D illustrate bubble formation on an interior rough surface of a fluid lens, and an example approach to bubble formation reduction or prevention. FIGS. 8A-81 illustrate various possible approaches to fabrication of a fluid lens with a reduced propensity for bubble formation. FIGS. 9 and 10 illustrate example methods of fabricating a fluid lens having an interior coating. FIGS. 11-16 illustrate example augmented reality and/or virtual reality devices, that may include one or more fluid lenses.

In fluid lenses, the application of negative pressure (e.g., reduced pressure in the liquid enclosure) may increase the possibility of bubble formation on an interior surface of the lens enclosure. Bubble formation may be induced by nucleation on surface defects. Bubble formation may be reduced by having a lens fluid that is maintained above atmospheric pressure, so that it is energetically unfavorable for a bubble to form. However, this may restrict the adjustments that are available to a surface of the fluid lens, for example, to convex lens surfaces only. A greater range of optical powers may be achieved by applying a negative pressure to the lens fluid, which may induce a concave membrane profile. (In this context, the term “concave” may refer to the external surface of the membrane, with a concave lens tending to be narrower in the center of the lens.) However, any design requirement of elevated fluid pressure (relative to atmospheric pressure) may be in direct conflict with such device configurations. Bubble formation may also be reduced by fabricating relatively small diameter lenses (e.g., a smaller diameter than typically used for ophthalmic lenses) that may have relatively low tension membranes. However, the applications of such reduced diameter lenses may be correspondingly restricted.

In some examples, an adjustable fluid lens (such as a liquid lens) includes a pre-strained flexible membrane that at least partially encloses a fluid volume, a fluid enclosed within the fluid volume, a flexible edge seal that defines a periphery of the fluid volume, and an actuation system configured to control the edge of the membrane such that the optical power of the lens can be modified. In some examples, movement of an edge portion of the membrane, such as a control point, along a guide path provided by a support structure may result in no appreciable change in the elastic energy of the membrane. The membrane profile may be adjusted by movement of a plurality of control points along respective guide paths, and this may result in no appreciable change in the elastic energy of the membrane. The membrane may be an elastic membrane, and the membrane profile may be a curved profile providing a refractive surface of the fluid lens.

FIG. 1A depicts a cross-section through a fluid lens, according to some examples. The fluid lens 100 illustrated in this example includes a substrate 102 (which in this example is a generally rigid, planar substrate), a substrate coating 104, a membrane 106, a fluid 108 (denoted by dashed horizontal lines), an edge seal 110, a support structure 112 providing a guide surface 114, and a membrane attachment 116. In this example, the substrate 102 has a lower (as illustrated) outer surface, and an interior surface on which the substrate coating 104 is supported. The interior surface 120 of the substrate coating 104 is in contact with the fluid 108. The membrane 106 has an upper (as illustrated) outer surface and an interior surface 122 bounding the fluid 108. The substrate coating 104 may be optional.

The fluid 108 is enclosed within an enclosure 118, which is at least in part defined by the substrate 102 (along with the substrate coating 104), the membrane 106, and the edge seal 110, which here cooperatively define the enclosure 118 in which the fluid 108 is located. The edge seal 110 may extend around the periphery of the enclosure 118, and retain (in cooperation with the substrate and the membrane) the fluid within the enclosed fluid volume of the enclosure 118. In some examples, an enclosure may be referred to as a cavity or lens cavity.

In this example, the membrane 106 has a curved profile, so that the enclosure has a greater thickness in the center of the lens than at the periphery of the enclosure (e.g., adjacent the edge seal 110). In some examples, the fluid lens may be a plano-convex lens, with the planar surface being provided by the substrate 102 and the convex surface being provided by the membrane 106. A plano-convex lens may have a thicker layer of lens fluid around the center of the lens. In some examples, the exterior surface of a membrane may provide the convex surface, with the interior surface being substantially adjacent the lens fluid.

The support structure 112 (which in this example may include a guide slot through which the membrane attachment 116 may extend) may extend around the periphery (or within a peripheral region) of the substrate 102, and may attach the membrane to the substrate. The support structure may provide a guide path, in this example a guide surface 114 along which a membrane attachment 116 (e.g., located within an edge portion of the membrane) may slide. The membrane attachment may provide a control point for the membrane, so that the guide path for the membrane attachment may provide a corresponding guide path for a respective control point.

The fluid lens 100 may include one or more actuators (not shown in FIG. 1A) that may be located around the periphery of the lens and may be part of or mechanically coupled to the support structure 112. The actuators may exert a controllable force on the membrane at one or more control points, such as provided by membrane attachment 116, that may be used to adjust the curvature of the membrane surface and hence at least one optical property of the lens, such as focal length, astigmatism correction, surface curvature, cylindricity, or any other controllable optical property. In some examples, the membrane attachment may be attached to an edge portion of the membrane, or to a peripheral structure extending around the periphery of the membrane (such as a peripheral guide wire, or a guide ring), and may be used to control the curvature of the membrane.

In some examples, FIG. 1A may represent a cross-section through a circular lens, though examples fluid lenses may also include non-circular lenses, as discussed further below.

FIG. 1B shows a fluid lens, of which FIG. 1A may be a cross-section. The figure shows the fluid lens 100, including the substrate 102, the membrane 106, and the support structure 112. In this example, the fluid lens 100 may be a circular fluid lens. The figure shows the membrane attachment 116 as moveable along a guide path defined by the guide slot 130 and the profile of the guide surface 114 (shown in FIG. 1A). The dashed lines forming a cross are visual guides indicating a general exterior surface profile of the membrane 106. In this example, the membrane profile may correspond to a plano-convex lens.

FIG. 1C shows a non-circular lens 150 that may otherwise be similar to the fluid lens 100 of FIG. 1B and may have a similar configuration. The non-circular lens 150 includes substrate 152, membrane 156, and support structure 162. The lens has a similar configuration of the membrane attachment 166, movable along a guide path defined by the guide slot 180. The profile of a guide path may be defined by the surface profile of the support structure 162, through which the guide slot is formed. The cross-section of the lens may be analogous to that of FIG. 1A. The dashed lines forming a cross on the membrane 156 are visual guides indicating a general exterior surface profile of the membrane 156. In this example, the membrane profile may correspond to a plano-convex lens.

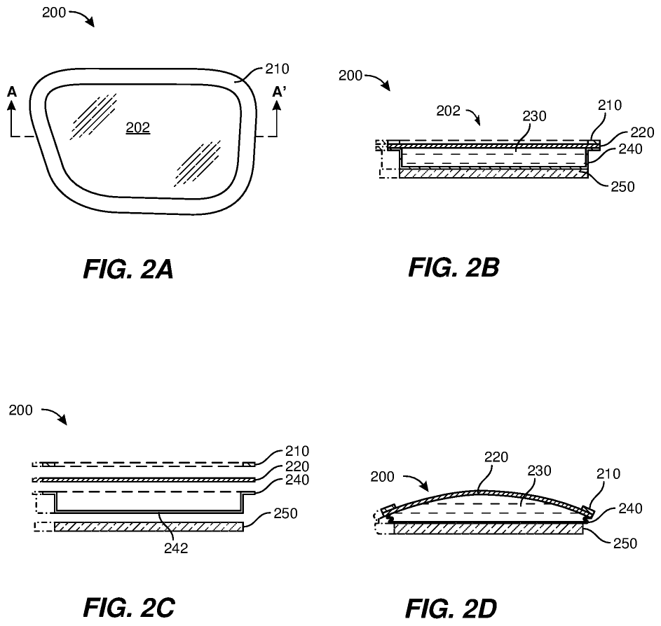

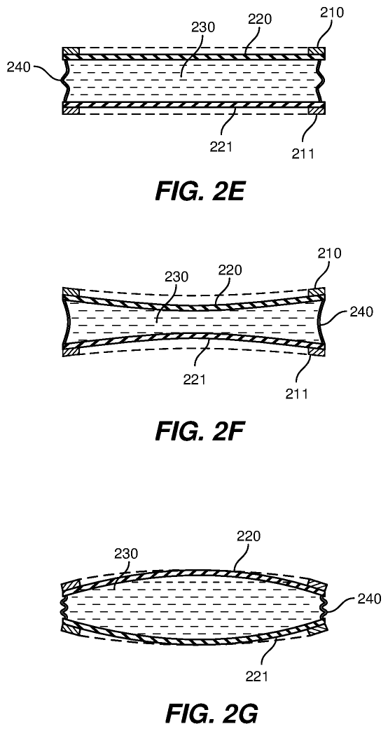

FIGS. 2A-2D illustrate an ophthalmic device 200 including a fluid lens 202, according to some examples. FIG. 2A shows a portion of an ophthalmic device 200, which includes a portion of a peripheral structure 210 (that may include a guide wire or a support ring) supporting a fluid lens 202.

In some examples, the lens may be supported by a frame. An ophthalmic device (e.g., spectacles, goggles, eye protectors, visors, and the like) may include a pair of fluid lenses, and the frame may include components configured to support the ophthalmic device on the head of a user, for example, using components that interact with (e.g., rest on) the nose and/or ears of the user.

FIG. 2B shows a cross-section through the ophthalmic device 200, along A-A′ as shown in FIG. 2A. The figure shows the peripheral structure 210 and the fluid lens 202. The fluid lens 202 includes a membrane 220, lens fluid 230, an edge seal 240, and a substrate 250. In this example, the substrate 250 includes a generally planar, rigid layer. The figure shows that the fluid lens may have a planar-planar configuration, which in some examples may be adjusted to a plano-concave and/or plano-convex lens configuration.

In some examples disclosed herein, one or both surfaces of the substrate may include a concave or convex surface, and in some examples the substrate may have a non-spherical surface such as a toroidal or freeform optical progressive or digressive surface. In various examples, the substrate may include a plano-concave, plano-convex, biconcave, biconvex, or concave-convex (meniscus) lens, or any other suitable optical element. In some examples, one or both surfaces of the substrate may be curved. For example, a fluid lens may be a meniscus lens having a substrate (e.g., a generally rigid substrate having a concave exterior substrate surface and a convex interior substrate surface), a lens fluid, and a convex membrane exterior profile. The interior surface of a substrate may be adjacent to the fluid, or adjacent to a coating layer in contact with the fluid.

FIG. 2C shows an exploded schematic of the device shown in FIG. 2B, in which corresponding elements have the same numbering as discussed above in relation to FIG. 2A. In this example, the edge seal is joined with a central seal portion 242 extending over the substrate 250.

In some examples, the central seal portion 242 and the edge seal 240 may be a unitary element. In other examples, the edge seal may be a separate element, and the central seal portion 242 may be omitted or replaced by a coating formed on the substrate. In some examples, a coating may be deposited on the interior surface of the seal portion and/or edge seal. In some examples, the lens fluid may be enclosed in a flexible enclosure (sometimes referred to as a bag) that may include an edge seal, a membrane, and a central seal portion. In some examples, the central seal portion may be adhered to a rigid substrate component and may be considered as part of the substrate. In some examples, the coating may be deposited on at least a portion of the enclosure surface (e.g., the interior surface of the enclosure). The enclosure may be provided, at least in part, by one or more of the following; a substrate, an edge seal, a membrane, a bag, or other lens component. The coating may be applied to at least a portion of the enclosure surface at any suitable stage of lens fabrication, for example, to one or more lens components (e.g., the interior surface of a substrate, membrane, edge seal, bag, or the like) before, during, or after lens assembly. For example, a coating may be formed before lens assembly (e.g., during or after fabrication of lens components); during lens assembly; after assembly of lens components but before introduction of the fluid to the enclosure; or by introduction of a fluid including a coating material into the enclosure. In some examples, a coating material (such as a coating precursor) may be included within the fluid introduced into the enclosure. The coating material may form a coating on at least a portion of the enclosure surface adjacent the fluid.

FIG. 2D shows adjustment of the device configuration, for example, by adjustment of forces on the membrane using actuators (not shown). As shown, the device may be configured in a planar-convex fluid lens configuration. In an example plano-convex lens configuration, the membrane 220 tends to extend away from the substrate 250 in a central portion.

In some examples, the lens may also be configured in a planar-concave configuration, in which the membrane tends to curve inwardly towards the substrate in a central portion.

FIG. 2E illustrates a similar device to FIG. 2B, and element numbering is similar. However, in this example, the substrate 250 of the example of FIG. 2B is replaced by a second membrane 221, and there is a second peripheral structure (such as a second support ring) 211. In some examples disclosed herein, the membrane 220 and/or the second membrane 221 may be integrated with the edge seal 240.

FIG. 2F shows the dual membrane fluid lens of FIG. 2E in a biconcave configuration. For example, application of negative pressure to the lens fluid 230 may be used to induce the biconcave configuration. In some examples, the membrane 220 and second membrane 221 may have similar properties, and the lens configuration may be generally symmetrical, for example, with the membrane and second membrane having similar radii of curvature (e.g., as a symmetric biconvex or biconcave lens). In some examples, the lens may have rotational symmetry about the optical axis of the lens, at least within a central portion of the membrane, or within a circular lens. In some examples, the properties of the two membranes may differ (e.g., in one or more of thickness, composition, membrane tension, or in any other relevant membrane parameter), and/or the radii of curvature may differ. In these examples, the membrane profiles have a negative curvature, that corresponds to a concave curvature. The membrane profile may relate to the external shape of the membrane. A negative curvature may have a central portion of the membrane closer to the optical center of the lens than a peripheral portion (e.g., as determined by radial distances from the center of the lens).

FIG. 2G shows the dual membrane fluid lens of FIG. 2E in a biconvex configuration, with corresponding element numbers.

In some examples, an ophthalmic device, such as an eyewear device, includes one or more fluid lenses. An example device includes at least one fluid lens supported by eyeglass frames. In some examples, an ophthalmic device may include an eyeglass frame, goggles, or any other frame or head-mounted structure to support one or more fluid lenses, such as a pair of fluid lenses.

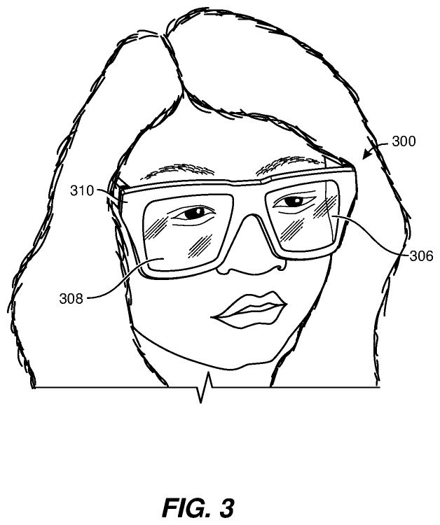

FIG. 3 illustrates an ophthalmic device, in this example an eyewear device, including a pair of fluid lenses, according to some examples. The eyewear device 300 may include a pair of fluid lenses (306 and 308) supported by a frame 310 (which may also be referred to as an eyeglass frame). The pair of fluid lenses 306 and 308 may be referred to as left and right lenses, respectively (from the viewpoint of the user).

In some examples, an eyewear device (such as eyewear device 300 in FIG. 3) may include a pair of eyeglasses, a pair of smart glasses, an augmented reality device, a virtual reality headset, an augmented reality device, or the like. In some examples, a head-mounted device may be or include an eyewear device. An eyewear device may be or include an augmented reality headset, virtual reality headset, ophthalmic device (such as eyeglasses or spectacles), smart glasses, visor, goggles, other eyewear, or other device. An ophthalmic device may include fluid lenses that have an optical property (such as an optical power, astigmatism correction, cylindricity, or other optical property) corresponding to a prescription, for example, as determined by an eye examination. An optical property of the lens may be adjustable, for example, by a user or by an automated system. Adjustments to the optical property of a fluid lens may be based on the activity of a user, the distance to an observed article, or other parameter. In some examples, one or more optical properties of an eyewear device may be adjusted based on a user identity. For example, an optical property of one or more lenses within an AR and/or VR headset may be adjusted based on the identity of the user, which may be determined automatically (e.g., using a retinal scan) or by a user input.

In some examples, a device may include a frame (such as an eyeglass frame) that may include or otherwise support one or more of any of the following: a battery, a power supply or power supply connection, other refractive lenses (including additional fluid lenses), diffractive elements, displays, eye-tracking components and systems, motion tracking devices, gyroscopes, computing elements, health monitoring devices, cameras, and/or audio recording and/or playback devices (such as microphones and speakers). The frame may be configured to support the device on a head of the user.

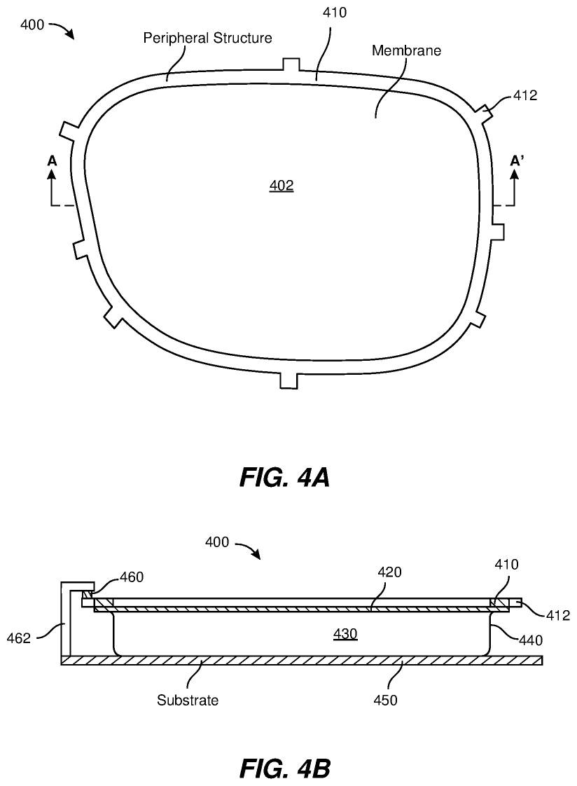

FIG. 4A shows an example fluid lens 400 including a peripheral structure 410 that may generally surround a fluid lens 402. The peripheral structure 410 (in this example, a support ring) includes membrane attachments 412 that may correspond to the locations of control points for the membrane of the fluid lens 402. A membrane attachment may be an actuation point, where the lens may be actuated by displacement (e.g., by an actuator acting along the z-axis) or moved around a hinge point (e.g., where the position of the membrane attachment may be an approximately fixed distance “z” from the substrate). In some examples, the peripheral structure and hence the boundary of the membrane may flex freely between neighboring control points. Hinge points may be used in some examples to prevent bending of the peripheral structure (e.g., a support ring) into energetically favorable, but undesirable, shapes.

A rigid peripheral structure, such as a rigid support ring, may limit adjustment of the control points of the membrane. In some examples, such as a non-circular lens, a deformable or flexible peripheral structure, such as a guide wire or a flexible support ring, may be used.

FIG. 4B shows a cross-section of the example fluid lens 400 (e.g., along A-A′ as denoted in FIG. 4A). The fluid lens includes a membrane 420, fluid 430, edge seal 440, and substrate 450. In some examples, the peripheral structure 410 may surround and be attached to the membrane 420 of the fluid lens 402. The peripheral structure may include membrane attachments 412 that may provide the control points for the membrane. The position of the membrane attachments (e.g., relative to a frame, substrate, or each other) may be adjusted using one or more actuators, and used to adjust, for example, the optical power of the lens. A membrane attachment having a position adjusted by an actuator may also be referred to as an actuation point, or a control point.

In some examples, an actuator 460 may be attached to actuator support 462, and the actuator may be used to vary the distance between the membrane attachment and the substrate, for example, by urging the membrane attachment along an associated guide path. In some examples, the actuator may be located on the opposite side of the membrane attachment from the substrate. In some examples, an actuator may be located so as to exert a generally radial force on the membrane attachment and/or support structure, for example, exerting a force to urge the membrane attachment towards or away from the center of the lens.

In some examples, one or more actuators may be attached to respective actuator supports. In some examples, an actuator support may be attached to one or more actuators. For example, an actuator support may include an arcuate, circular, or other shaped member along which actuators are located at intervals. Actuator supports may be attached to the substrate, or, in some examples, to another device component such as a frame. In some examples, the actuator may be located between the membrane attachment and the substrate, or may be located at another suitable location. In some examples, the force exerted by the actuator may be generally directed along a direction normal to the substrate, or along another direction, such as along a direction at a non-normal direction relative to the substrate. In some examples, at least a component of the force may be generally parallel to the substrate. The path of the membrane attachment may be based on the guide path, and in some examples the force applied by the actuator may have at least an appreciable component directed along the guide path.

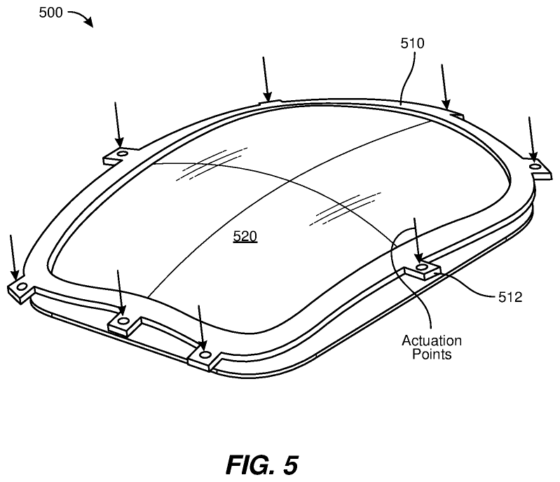

FIG. 5 shows an example fluid lens 500 including a peripheral structure 510, here in the form of the support ring including a plurality of membrane attachments 512, and extending around the periphery of a membrane 520. The membrane attachments may include or interact with one or more support structures that each provide a guide path for an associated control point of the membrane 520. Actuation of the fluid lens may adjust the location of one or more control points of the membrane, for example, along the guide paths provided by the support structures. Actuation may be applied at discrete points on the peripheral structure, for example, the membrane attachments shown. In some examples, the peripheral structure may be flexible, for example, so that the peripheral structure may not be constrained to lie within a single plane.

In some examples, a fluid lens includes a membrane, a support structure, a substrate, and an edge seal. The support structure may be configured to provide a guide path for an edge portion of the membrane (such as a control point provided by a membrane attachment). An example membrane attachment may function as an interface device, configured to mechanically interconnect the membrane and the support structure, and may allow the membrane to exert an elastic force on the support structure. A membrane attachment may be configured to allow the control point of the membrane (that may be located in an edge portion of the membrane) to move freely along the guide path.

An adjustable fluid lens may be configured so that adjustment of the membrane profile (e.g., an adjustment of the membrane curvature) may result in no appreciable change in the elastic energy of the membrane, while allowing modification of an optical property of the lens (e.g., a focal length adjustment). This configuration may be termed a “zero-strain” device configuration as, in some examples, adjustment of at least one membrane edge portion, such as at least one control point, along a respective guide path does not appreciably change the strain energy of the membrane. In some examples, a “zero-strain” device configuration may reduce the actuation force required by an order of magnitude when compared with a conventional support beam type configuration. A conventional fluid lens may, for example, require an actuation force that is greater than 1N for an actuation distance of 1 mm. Using a “zero-strain” device configuration, actuation forces may be 0.1N or less for an actuation of 1 mm, for quasi-static actuation. This substantial reduction of actuation forces may enable the use of smaller, more speed-efficient actuators in fluid lenses, resulting in a more compact and efficient form factor. In such examples, in a “zero-strain” device configuration, the membrane may actually be under appreciable strain, but the total strain energy in the membrane may not change appreciably as the lens is adjusted. This may advantageously greatly reduce the force used to adjust the fluid lens.

In some examples, a fluid lens may be configured to have one or both of the following features: in some examples, the strain energy in the membrane is approximately equal for all actuation states; and in some examples, the force reaction at membrane edge is normal to the guide path. Hence, in some examples, the strain energy of the membrane may be approximately independent of the optical power of the lens. In some examples, the force reaction at the membrane edge is normal to the guide path, for some or all locations on the guide path.

In some examples, movement of the edge portion of the membrane along the guide path may not result in an appreciable change in the elastic energy of the membrane. This configuration may be termed a “zero-strain” guide path as, in some examples, adjustment of the membrane edge portion along the guide path does not appreciably change the strain energy of the membrane.

FIG. 6A shows a fluid lens 600 according to some examples, as a view from the front of the fluid lens 600. The fluid lens 600 may include a membrane 620 that is held at its periphery by bendable support ring 610. The membrane 620 may be a tensioned distensible membrane.

FIG. 6B illustrates the fluid lens 600 in cross-section, for example, along line A-A′ denoted in FIG. 6A. The fluid lens 600 includes lens fluid 630 enclosed by the membrane 620 and an edge seal 640, and including a rigid substrate (that may be a rigid lens) 650. In some examples, the membrane 620, edge seal 640, and optionally an additional layer (not shown) may be interconnected to form a collapsible bag that may enclose the lens fluid. In some examples, the edge seal 640 and the membrane 620 may be joined to one another using ultrasonic welding, an adhesive, or other methods or combination of methods. The fluid lens 600 may be an adjustable liquid-filled lens.

FIG. 6C shows the example lens in a concave membrane configuration that may be effected by moving the bendable support ring 610 away from the substrate 650, for example, using an actuator (not shown). This may be used to provide a plano-concave lens configuration.

In some examples, a concave membrane surface may be achieved by reducing pressure on the lens fluid, and optionally by removing lens fluid from the enclosure. Reducing pressure on the lens fluid may reduce gas solubility within the fluid, and may lead to the formation of bubbles within the fluid. These may have negative effects on the lens quality, for example, by scattering light, and may degrade the appearance of a fluid lens.

FIGS. 7A-7D illustrate a possible mechanism for bubble formation in a fluid lens 700.

FIG. 7A shows a fluid lens 700 including a frame (or support ring) 710, membrane 720, fluid 730, edge seal 740, and substrate 750. As illustrated in this figure, fluid 730 may include bubbles, such as bubble 745.

The lower portion of FIG. 7A shows a more detailed representation of the surface roughness of the substrate 750. A bubble 735 may nucleate and grow within a recess 754 (e.g., a depression, indentation, or similar) within the interior surface 752 of the substrate 750. In some cases, the substrate surface in contact with (or more proximate to) the fluid may be referred to as the interior surface of the substrate. The recess 754 may include, for example, a scratch, a pit, or other surface imperfection of the interior surface 752 of the substrate 750.

The interior surface 752 of the substrate 750 may have a surface roughness, which may be represented illustratively by surface deviations from planarity, such as projections and recesses. These deviations from a mean surface profile may be generally referred to as surface defects.

The interior surfaces of the enclosure, such as the interior surfaces of the substrate, edge seal, or membrane, may each have an appreciable surface roughness, and may include surface defects that may act as nucleation sites for bubble formation during operation of the lens.

FIG. 7B shows the bubble 735 further growing in size.

FIG. 7C shows the bubble 748 floating away from the interior surface 752 and into the bulk of the fluid 730. Another bubble 738 may nucleate in the same (or different) location from the surface defect which nucleated the bubble 748.

FIG. 7D shows a fluid lens 760, according to some examples. The elements and corresponding element numbers are generally the same as discussed above in relation to FIGS. 7A-7C, and are not repeated. However, compared to the lens of FIG. 7A, fluid lens 760 further includes a coating 770, which in this example may be located adjacent the interior of the enclosure (e.g., located on the interior surface 752 of the substrate 750). The coating has an interior surface 765, where the interior surface is a fluid-facing surface. In some examples, the coating 770, when deposited on the interior surface 752 of the substrate 750, is self-leveling with respect to the surface on which the coating is deposited (e.g., an interior surface).

In some examples, coating 770 may be applied to interior surface 752 of the substrate 750 by introducing a liquid or a vapor into the enclosure. In some examples, the coating material may be polymerized or otherwise cured, after deposition of a coating material, before the fluid 730 is introduced to the lens enclosure. In some examples, the fluid 730 may be an optical fluid, such as an optical liquid. The coating material introduced into the enclosure may be or include a precursor to the final coating composition. For example, the coating material may include a monomer or other polymerizable material, and the coating may include a polymer formed by polymerizing the monomer or other polymerizable material.

In some examples, a coating material, such as a coating precursor, may be added to the fluid as a dissolved component, or in suspension, for example, as a component of an emulsion. A coating material may interact with the surface to form a coating. In some examples, the coating may be formed by a precursor coating, for example, by polymerization and/or cross-linking of a coating precursor.

In some examples, a coating material may be added to the fluid 730, and may be deposited on the interior surface of the enclosure from the fluid, when the fluid is introduced to the enclosure. The coating material may be a liquid, and in some examples may be immiscible with fluid 730. The coating material may deposit on, adhere to, or otherwise interact with the inside of the enclosure.

The interior surface 765 of the coating (that may be in contact with the lens fluid) may be relatively smooth, for example, relative to the surface on which the coating is deposited, and may provide essentially no, or a greatly reduced number of, nucleation sites, so that bubble formation may become negligible (e.g., vanishingly unlikely) in normal use of the fluid lens.

In some examples, the coating 770 may include a liquid coating. A liquid coating may include a liquid component that is immiscible with the lens fluid. A liquid coating may have the further property that the liquid coating scavenges particulate contaminants in the optical fluid, which may further reduce nucleation site availability for the lens fluid. In some examples, a liquid coating does not cavitate when under negative pressure, under normal operating conditions. A liquid coating may have a low vapor pressure, and may have a low gas solubility. In some examples, a liquid coating may be retained against the surface by hydrophobic or hydrophilic interactions with the surface. In some examples, a liquid coating may include polar molecules that may interact with polar groups on the substrate surface (or any other surface to be coated). For example, the substrate surface may include one or more species of polar groups. For example, a glass substrate surface may include silanol groups. A polar liquid may be introduced as a film between, for example, a hydrophobic lens fluid and a polar surface, and may be retained as a polar liquid layer adjacent the polar substrate surface by polar interactions, such as van der Waals interactions, and the like. In some examples, a substrate surface may be coated with a monolayer, such as a self-assembling monolayer. In some examples, the monolayer may include long flexible groups, such as long aliphatic chains (e.g., C10-C30 aliphatic chains, such as alkyl groups) that may tend in aggregate to smooth out the surface roughness of the substrate surface.

FIGS. 8A-81 show various aspects of example approaches to preparing a fluid lens. FIGS. 8A-8B show an example fluid lens, with FIG. 8A being an exploded view not showing the lens fluid. The fluid lens 800 includes a peripheral structure 810, a membrane 820, an edge seal 840, and a substrate 850. The fluid lens 800 may include a fill port 841 and a vent port 842 that may be included as a component of the edge seal 840. Lens components, such as the edge seal 840, may be molded, thermoformed from a film, or manufactured by other means as appropriate. The edge seal may be elastomeric or compliant, and may deform during lens actuation.

FIG. 8C shows the coating material 835 introduced to the enclosure through the fill port 841. The figure shows an injection method including a syringe and needle 836, but any suitable pump may be used. In some examples, the coating material 835 may be a liquid as shown here.

FIG. 8D shows that ultrasonic agitation may be used to spread the coating material over interior surfaces of the enclosure, forming a coating 860 on the interior surface of the membrane, and a coating 870 on the interior surface of the substrate.

Alternatively, the coating material 835 may be injected into the enclosure as a vapor that condenses on the interior surfaces. In some examples, the vapor material may include an aerosol. When an even coating of the interior surfaces has been achieved, the coating may be polymerized (e.g., cured) using one or more of ultraviolet radiation, catalysis, or other suitable approach.

FIG. 8E shows the use of UV (ultraviolet) radiation to polymerize the coatings 860 and 870.

FIG. 8F shows the lens enclosure being filled with lens fluid 830 using a syringe and needle. Injection may be achieved using a syringe and needle 836, or other suitable pump. Once the lens enclosure is filled with lens fluid, the fill port 841 and vent port 842 (shown in FIG. 8B) may be sealed.

FIGS. 8G and 8H show elevation and perspective views, respectively, of the edge seal 840, and example locations of fill port 841 and vent port 842.

FIG. 81 illustrates a method of sealing the lens using an anvil (including anvil base 880 and anvil component 875). An ultrasonic horn may be used to seal components and ports closed. Other sealing approaches, such as bungs or plugs, or liquid adhesive, may be used.

FIG. 9 illustrates an example method 900 of fabricating a fluid lens. The method includes introducing a coating material into the interior enclosure of a fluid lens (910), agitating the coating material to deposit the coating material onto one or more interior surfaces (920), polymerizing the coating material to form a coating (930), and introducing a lens fluid into the enclosure to form the fluid lens (940).

FIG. 10 illustrates an example method 1000 of fabricating a fluid lens. The method includes introducing a lens fluid into the interior enclosure of a fluid lens (1010), forming a coating on one or more interior surfaces of the enclosure using a coating material component of the lens fluid (1020), and polymerizing the coating to form the fluid lens (1030).

Examples described herein include a fluid lens, such as a liquid lens, having a relatively low-nucleating enclosure (e.g., using a coating to reduce the number of bubble nucleation sites). In some examples, a fluid lens may have an effectively non-nucleating lens enclosure. In this context, a low-nucleating lens enclosure may be a lens enclosure having a reduced propensity for formation of bubbles in the enclosed fluid, with the reduction being due to the coating. A non-nucleating lens enclosure may be a lens enclosure having no appreciable propensity for formation of bubbles in the enclosed fluid.

In some examples, the surface of a fluid lens enclosure (which may be referred to herein as the “fluid volume” or the “enclosure”) has a coating disposed between one or more interior surfaces of the enclosure and the enclosed fluid. The coating may substantially eliminate, or otherwise reduce, the number of nucleation sites for gas bubbles to form within the enclosure fluid. The coating may significantly reduce the probability of bubble formation within the enclosure, for example, by reducing the number of bubbles formed in the lens fluid for a given device condition (e.g., for a given temperature and/or optical parameter) by a factor of 2 or more, for example, when comparing a coated substrate with an uncoated substrate. The reduction in bubble formation may be particularly advantageous when the lens has a negative gage pressure (e.g., for a concave membrane). For example, a lens with an uncoated substrate may be prone to bubble formation on the substrate when the gage pressure is negative, and the lens is in, for example, a plano-concave state. However, a coating on the substrate surface may appreciably reduce or substantially eliminate bubble formation.

In some examples, the coating may include a solid, especially a low modulus solid, a gel, or an immiscible fluid such as a colloid, suspension, emulsion, hydrogel, or other fluid. In some examples, a low modulus solid may have a Young's modulus at least one order of magnitude less than that of the substrate. In some examples, a low modulus solid may include a low modulus polymer, such as a polymer having a Young's modulus at least one order of magnitude less than that of the substrate. In this context, a low modulus polymer may include an elastomer, a polymer having a low degree of polymerization (e.g., compared to that of a polymer substrate), or a polymer used to form a coating on a rigid glass substrate. In some examples, a polymer coating on the substrate surface may swell slightly on absorbing molecules of the lens fluid, that may reduce surface roughness (e.g., by helping to fill in surface depressions).

In some examples, a fluid lens, such as a liquid lens, includes an elastic membrane, a substrate, and a liquid filling an enclosure at least partially defined by the elastic membrane and the substrate. A coating may be applied to at least a portion of the enclosure surfaces, such as the membrane and/or substrate interior surfaces that define the enclosure and are in contact with the fluid when the enclosure is filled with the fluid. The enclosure surface may be an interior surface of the enclosure, proximate or adjacent the fluid. In some examples, the coating may be located between the enclosure surface and the fluid, and the coating surface roughness may be appreciably less than that of a corresponding uncoated enclosure surface.

In some examples, a device includes one or more fluid lenses. A fluid lens may include an enclosure including a fluid. The enclosure may be defined, at least in part, by lens components such as a membrane, a substrate (and/or a second substrate), and an optional edge seal. An example lens component may have an interior surface that may be substantially adjacent the enclosure. The interior surface may have a coating configured to appreciably reduce bubble formation on the interior surface during use of the fluid lens. Appreciable reduction may include a decrease in bubble numbers of approximately 25% or more under one or more particular operating conditions, such as approximately 50% or more, and may include substantial elimination of bubble formation. Appreciable reduction may be determined using a comparison of similar lenses having coated and uncoated interior surfaces under similar operating conditions, that may include application of a negative pressure to the fluid. In some examples, a lens may include a substrate, such as a transparent substrate, such as a rigid transparent substrate. In this context, a rigid substrate may show a relatively small mechanical deformation as the fluid pressure and/or volume is adjusted (e.g., as compared to the membrane). A relatively small mechanical deformation may be one that results in a relatively small change in an optical property of the lens, such as one that would not normally be perceptible to a human user during routine use of the device.

In some examples, a coating may be located between the substrate and the fluid. In some examples, the coating may be covalently bonded to a surface of the substrate. In some examples, the coating may be retained by the substrate by ionic or polar interactions. For example, the substrate may include a polar material, the bulk of the fluid may be non-polar, and a layer (e.g., a liquid coating) including a polar material, such as a polar liquid, may be located adjacent the substrate. In some examples, the layer may provide the coating. In some examples, the layer may be a precursor layer (a precursor coating) that may be further processed (e.g., polymerized) to form the coating.

In some examples, a substrate may include glass, such as a silicate glass, such as a borosilicate glass. A coating may interact with, or bond to, a glass surface, for example, using silicon-oxygen bonds, or other bonds. A coating may include a silicone polymer. A coating may include a polysiloxane having side-groups, such as hydrocarbon chains that may help reduce surface roughness. In some examples, a coating may include a self-assembled multilayer (SAM).

In some examples, a fluid lens component includes a polymer. A coating may include chemical groups that may form bonds to the polymer. For example, a substrate may include an acrylate polymer, and a coating material may include an acrylate material, that may, for example, be polymerized to form an acrylate polymer coating and that may also form bonds to unpolymerized or end groups within the polymer. In some examples, a fluid lens component and a coating may include polymers formed from chemically-related polymerizable materials (e.g., both substrate and coating may include an acrylate, urethane, and/or other particular polymer). In some examples, a substrate may be cross-linked, and the cross-linking process may both further stabilize the coating and introduce bonds between the coating and the substrate.

In some examples, the coating may include a polymer (e.g., an acrylate, silicone, epoxy, urethane, or other polymer, or co-polymers or blends thereof). In some examples, the coating may have a limited solubility in the fluid, and may, in some examples, have no significant solubility in the fluid.

In some examples, the coating may include a fluoropolymer, such as a polyfluoroethylene, such as polytetrafluorethylene.

In some examples, a method (e.g., a method of fabricating a fluid lens) includes preparing a fluid mixture, such as a liquid mixture, including a coating material, and filling the enclosure of a fluid lens with the fluid mixture. A coating may then form on the enclosure surface of the fluid lens. The coating may include or be formed from the coating material. In some examples, the coating material may be or include a coating precursor that may be used to form the coating. A coating precursor may include a polymerizable material (e.g., used to form a coating including a polymer), or a material that may otherwise react (e.g., with one or more of the substrate, other similar material, or other coating material component) to form the coating. Example methods may include a method of fabricating a fluid lens, or device including one or more fluid lenses. Example methods may include a method of applying a coating (such as a low-nucleation coating, that reduces the number of bubble nucleation sites) to the interior surface of the enclosure of a fluid lens. In some examples, a liquid mixture may be introduced to the enclosure, and may separate when in the enclosure of the fluid lens. For example, a non-polar component may form the lens fluid, and a polar component (or portion thereof) may interact with the enclosure surface to form the coating. A coating, such as a low-nucleation coating, may be formed from a mixture component including the coating material. In some examples, the mixture may include an emulsion of the coating material, for example, an emulsion of the coating material in a liquid (such as a high refractive index liquid). In some examples, the coating material and the fluid may be miscible. In some examples, the lens enclosure may be filled by the mixture at an elevated temperature.

In some examples, a method of fabricating a fluid lens includes introducing a lens fluid and a coating material (e.g., as a mixture, suspension, emulsion, solution, or other form) into the enclosure of a fluid lens that may be defined, at least in part, by a flexible membrane and a substrate. At least some of the coating material may form a layer on the interior surfaces of the enclosure, and the coating may then be formed from the layer of the coating material. Forming the coating may include polymerization of coating precursor (e.g., a precursor component of the coating material), such as photopolymerization of a monomer. In some examples, the substrate may be omitted and the enclosure formed by one or more membranes, such as two or more membranes, or a membrane assembly providing both exterior surfaces of the lens.

In some examples, formation of the coating may include a processing step such as polymerizing one or more precursor components of the coating material. In this context, a precursor may include a material that undergoes a further transformation (such as one or more of polymerization, cross-linking, adhesion to and/or reaction with a surface, or other process) as part of formation of the coating. For example, a precursor may be a monomer that may be polymerized to form a polymer component of the coating. The lens fluid of the fabricated lens may include one or more components originating from the coating material that do not become part of the coating, though the concentration may be sufficiently low as to not have an appreciable effect on the refractive index of the fluid.

In some examples, the coating material may include one or more polymerizable materials, such as one or more monomer molecular species. In some examples, the polymerizable material (such as a monomer) is polymerized after the fluid lens is filled with the mixture. Example coating materials (e.g., a coating precursor) may include one or more monomer molecular species, such as an epoxy, an acrylate (e.g., ethyl acrylate), a silicone (e.g., an alkylsiloxane, such as a dialkylsiloxane, such as dimethylsiloxane), or other suitable monomer. A polymerizable material, such as a monomer, may be polymerized (e.g., thermally polymerized, photopolymerized, or otherwise polymerized) and polymerization may optionally be promoted by addition of a catalyst or an initiator. In some examples, a polymerizable material may be polymerized using actinic radiation, such as UV and/or visible electromagnetic radiation, or an electron beam. A coating material may include one or more precursors, such as one or more polymerizable materials, and an additional processing step (such as polymerization) may be used to form the coating.

In some examples, a method (e.g., a method of applying a low-nucleating coating) includes forming a coating on the interior surfaces of the fluid lens enclosure, and filling the fluid lens enclosure with a fluid (such as a high refractive index fluid, such as a silicone oil). In some examples, the coating is further processed before filling the lens with a fluid. For example, the initially deposited coating may be subject to one or more of the following: drying (including vapor removal), heat treatment, polymerization, cross-linking, further chemical treatment, further coating deposition, and the like. In some examples, the coating may undergo further processes after the enclosure is filled with a fluid. In some examples, the coating may be dried after filling with a fluid, where, for example, any fluid components of the coating (such as a solvent) may evaporate through the membrane, or other lens component. In some examples, a polymerizable component of the coating may be polymerized after the enclosure is filled with a lens fluid.

In some examples, fluid lenses may have a coating formed on at least part of the enclosure surface to reduce (e.g., substantially eliminate) bubble formation in the fluid lens. In some examples, gas solubility in the lens fluid may also be reduced. In some examples, a lens fluid may be used that has a reduced propensity for bubble formation.

Reducing bubble formation allows negative pressures to be applied to the lens fluid of a fluid lens, allowing a greater range of focal lengths and/or optical powers to be achieved by a fluid lens. In some examples, a fluid lens may have a membrane that may be adjusted from a generally convex configuration, through a generally planar configuration, to a generally concave configuration, and vice versa. This allows the fabrication of thinner and/or lighter lens configurations. The availability of concave configurations also allows a greater range of optical powers to be achieved. In some examples, the substrate may have a curved exterior and/or interior surface profile, and may contribute to the optical power of the fluidic lens.

In some examples, a coating may include a liquid or other fluid, such as a gel or mucus, that may immiscible with the lens fluid and that preferentially adheres to the inside of the enclosure. In some examples, a coating may interact with the coated surface through one or more of chemical bonds, hydrogen bonds, or dipolar interactions.

In some examples, one or more lens components (such as a substrate, edge seal, or membrane) may be imparted with a coating (e.g., using a similar method to those described herein) before, during, or after assembly of the fluid lens.

In some examples, the interior surface of the enclosure may be further processed to reduce nucleation sites. For example, the membrane or substrate may be locally heated to assist in providing a smooth surface. A membrane or substrate may be heated, or otherwise processed, before, during, or after assembly of the fluid lens. In some examples, a portion of an interior surface, with or without a coating, may be exposed to IR radiation to induce local heating of the surface, and reduction of nucleation sites.

In some applications, a fluid lens may show gravity sag, which is a typically undesired variation of optical power with height due to a hydrostatic pressure gradient in the fluid lens. Gravity sag may be expressed as change in optical power with height (e.g., 0.25 D in 20 mm). In some examples, a coating may also modify the elastic properties of a membrane in such a way that gravity sag is reduced or substantially eliminated.

In some examples, a membrane may be subject to a surface treatment, such as a coating, that may be provided before or after fluid lens assembly. In some examples, a polymer may be applied to the membrane, such as a polymer coating, for example, a fluoropolymer coating. A fluoropolymer coating may include one or more fluoropolymers, such as polytetrafluoroethylene, or its analogs, blends, or derivatives.

In some examples of an improved fluid lens, these inside surfaces may be treated to reduce or substantially eliminate bubble formation within the fluid of a fluid lens. The number of nucleation sites for bubble formation may be reduced using a surface coating and/or other treatment. The surface coating may be formed on the interior surface of the enclosure before filling the enclosure with the fluid, and in some examples may occur after filing using components added to the fluid. For example, the surfaces may be coated with a polymer layer (e.g., by polymerizing a precursor layer, such as surface monomer layer), or with a fluid, gel, or emulsion layer that is immiscible with the lens liquid. A coating may include one or more of various materials, such as an acrylate polymer, a silicone polymer, an epoxy-based polymer, or a fluoropolymer. In some examples, a coating may include a fluoroacrylate polymer, such as perfluoroheptylacrylate, or other fluoroalkylated acrylate polymer.

Reducing the number of nucleation sites may prevent or lower the number of bubbles that may form within a fluid lens, particularly when the fluid within the lens is subject to negative pressure (e.g., pressure below ambient pressure). Allowing reduced pressures to be applied to the fluid, with appreciably reduced bubble formation, may increase (e.g., double) the optical power range of an adjustable lens, for example, by enabling lens adjustment from a convex to a concave lens.

In some examples, a device includes at least one fluid lens. One or more of the fluid lenses may include: a membrane; a substrate, such as a rigid substrate, having a substrate surface; a fluid located within an enclosure defined at least in part by the membrane and the substrate; and a coating disposed on at least a portion of the substrate surface. The coating may have a coating surface adjacent the fluid, and may be deposited on at least part of an interior surface of the enclosure, such as on the substrate. After formation of the coating, the coating may then provide an interior surface of the enclosure having fewer nucleation points for bubbles within the lens fluid than the original uncoated interior surface. The membrane may be an elastic membrane. In some examples, the coating and the membrane may have different compositions. The coating may significantly reduce bubble formation within the fluid, for example, by reducing the number of bubble nucleation points relative to the number of bubble nucleation points that would be provided by the original uncoated interior surface of the enclosure, under similar conditions. For example, the number of bubbles formed on the coating may be 50%, 25%, or, in some examples, 10%, or less, than the number of bubbles formed on an uncoated enclosure surface under similar conditions (e.g., for a similar device configuration and optical power, and similar ambient conditions such as temperature). In some examples, the coating may at least halve, substantially eliminate, or eliminate bubble nucleation points within the coated portion of the interior surface of the enclosure.

In some examples, the coating may be formed directly on a substrate, membrane, at least a portion of the enclosure surface, and/or on any another lens component. For example, a coating may be deposited by one or more deposition techniques, such as dipping, spin-coating, vapor deposition, mist deposition, pulsed electron deposition, sputtering, vacuum deposition, or any other suitable deposition technique. In some examples, the coating may not be removable as an intact film from the substrate. In some examples, the coating thickness may be in the range 0.1 microns-100 microns. In some examples, a coating precursor may be deposited to form a coating precursor layer, and the coating precursor layer may be further processed (e.g., in situ) to form the coating. For example, a coating precursor layer may include a polymerizable material (e.g., a monomer), that may then be polymerized to form a coating including a polymer. In some examples, the coating (or a coating precursor) may be deposited as a liquid. In some examples, the coating may include a liquid, and may be retained near, for example, the substrate or other coated surface by interactions such as one or more of dipole interactions, bonding (e.g., hydrogen bonding), surface energy related forces, or other interaction. For example, a coating including a polar liquid may be retained near a polar substrate, located between the polar substrate and the hydrophobic lens fluid such as a hydrophobic oil. In some examples, a coating may modify the surface energy of a corresponding uncoated enclosure surface by at least 50%.

In some examples, the coating surface may have a coating surface roughness that is significantly less than the surface roughness of an uncoated substrate (that may be termed a substrate surface roughness), or the surface roughness of at least a portion of the enclosure surface on which the coating is deposited. For example, the substrate surface (or enclosure surface) may have numerous surface defects that may be filled in or smoothed out by the coating. In some examples, an arithmetic surface roughness may be characterized by a mean deviation magnitude from the mean surface profile. In some examples, an r.m.s. surface roughness may be characterized by a root mean squared deviation from the mean surface. In some examples, the r.m.s. surface roughness of the coating may be less than that of an uncoated surface, such as an uncoated substrate. In some examples, the r.m.s. surface roughness of the coating may be in the range of approximately 0.01 to approximately 0.5 of the r.m.s. surface roughness of the corresponding uncoated surface, such as less than approximately 0.5, 0.2, 0.10.05, or 0.01 than the surface roughness of an uncoated surface.

In some examples, the coating may have a different composition from the membrane. In some examples, the coating and membrane may not be a unitary structure, so that the membrane and coating are separate elements. In some examples, the coating may be thinner than the membrane, for example, the coating may be less than half the thickness of the membrane. The membrane may be connected to the substrate (and/or the coating) using a separate edge seal. The edge seal may include a flexible polymer film, and deformation of the edge seal (e.g., during adjustment of the lens) may not have any appreciable effect on the optical properties of the lens.

In some examples, a coating may include a polymer, for example, a fluoropolymer, such as polytetrafluoroethylene (PTFE). A polymer coating, such as a fluoropolymer coating, may be deposited by vapor deposition or any other suitable process. In some examples, a surface may be coated with polymer particles, and the coating may be formed by further processing of the polymer particles, such as further polymerization, cross-linking, melting (e.g., localized melting using radiation absorption, such as IR absorption), or other suitable process.

In some examples, a fluid lens includes a substrate, a flexible membrane, and a fluid-filled enclosure located, at least in part, between the substrate and the flexible membrane. Bubble formation may reduce optical quality and aesthetics of the fluid lens. It may be desirable to apply reduced pressure to fluid in the cavity, and in some examples negative pressure (less than ambient) may be applied, for example, to obtain a concave lens exterior surface. Lower pressures may increase the possibility of bubble formation on the interior surfaces of the substrate and membrane. In some examples of an improved fluid lens, a coating may be applied to these surfaces to reduce or substantially eliminated bubble formation within the fluid of the fluid lens. The number of nucleation sites for bubble formation may be reduced or substantially eliminated using a coating and/or other surface treatment. The coating may be formed before filling the enclosure with the fluid, and in some examples may occur after filing using components added to the fluid. For example, the surfaces may be coated with a polymer layer (e.g., by polymerizing a surface monomer layer), or with a fluid, gel, or emulsion layer that is immiscible with the lens liquid. Coatings may include one or more of various materials, including acrylate, silicone, and epoxy-based polymers. Allowing reduced pressure to be applied to the fluid, without bubble formation, may increase the optical power range of an adjustable lens, for example, by enabling lens adjustment from a convex to a concave lens. Ophthalmic applications include spectacles with a flat or curved (concave or convex) front substrate and an adjustable eye-side concave membrane surface. An eye-side surface may be adjusted between concave profiles, or between concave and convex and/or planar profiles. In this context, a profile may be an exterior surface form of a lens surface.

In some examples, a fluid lens may include a peripheral structure, such as a support ring, or a peripheral wire. A peripheral structure may include a support member affixed to the perimeter of a distensible membrane in a fluid lens. The peripheral structure may have generally the same shape as the lens periphery. In some examples, non-round fluid lens may include a peripheral structure that may bend normally to a plane, for example, a plane corresponding to the membrane periphery for a round lens. The peripheral structure may also bend tangentially to the membrane periphery.

A fluid lens may include a membrane, such as a distensible membrane. A membrane may include a thin sheet or film (having a thickness less than its width or height). The membrane may provide the deformable optical surface of an adjustable fluid lens. The membrane may be under a line tension, that may be the surface tension of the membrane. Membrane tension may be expressed in units of N/m.

In some examples, a device includes a membrane, a support structure configured to provide a guide path for an edge portion of the membrane, an interface device which connects the membrane, or a peripheral structure disposed around the periphery of the membrane, to the support structure and allows the membrane to move freely along the guide path, a substrate, and an edge seal. In some examples, the support structure may be rigid, or semi-rigid.

In some examples, an adjustable fluid-filled lens may include a membrane assembly. A membrane assembly may include a membrane (e.g., having a line tension), and a wire or other structure extending around the membrane (e.g., a peripheral guide wire). A fluid lens may include a membrane assembly, a substrate, and an edge seal. In some examples, the membrane line tension may be supported by a support ring. This may be augmented by a static restraint and/or a hinge point at one or more locations on the support ring.

In some examples, a fluid lens may include a membrane, a support structure configured to provide a guide path for an edge portion of the membrane, and a substrate. The fluid lens may further include an interface device, configured to connect the membrane to the support structure and to allow the edge portion of the membrane to move freely along the guide path, a substrate, and an edge seal. In some examples, fluid lenses may include lenses having an elastomeric or otherwise deformable element (such as a membrane), a substrate, and a fluid. In some examples, movement of a control point of the membrane, for example, as determined by the movement of a membrane attachment along a guide path, may be used to adjust the optical properties of a fluid lens.

Example embodiments include apparatus, systems, and methods related to fluid lenses. In some examples, the term “fluid lens” may include adjustable fluid-filled lenses, such as adjustable liquid-filed lenses.

In some examples, a fluid lens, such as an adjustable fluid-filled lens, may include a pre-strained flexible membrane which at least partially encloses a fluid volume, a fluid enclosed within the fluid volume, and a flexible edge seal which defines a periphery of the fluid volume, and an actuation system configured to control the edge of the membrane such that the optical power of the lens can be modified. The fluid volume may be referred to as an enclosure.

Controlling the edge of the membrane may require energy to deform the membrane, and/or energy to deform a peripheral structure such as a support ring, or a wire (e.g., in the case of a non-round lens). In some examples, a fluid lens configuration may be configured to reduce the energy required to change the power of the lens to a low value, for example, such that the change in elastic energy stored in the membrane as the lens properties change may be less than the energy required to overcome, for example, frictional forces.

In some examples, an adjustable focus fluid lens includes a substrate and an membrane (e.g., an elastic membrane), where a lens fluid is retained between the membrane and the substrate. The membrane may be under tension, and a mechanical system for applying or retaining the tension in the membrane at sections may be provided along the membrane edge or at portions thereof. The mechanical system may allow the position of the sections to be controllably changed in both height and radial distance. In this context, height may refer to a distance from the substrate, along a direction normal to the local substrate surface. In some examples, height may refer to the distance from a plane extending through the optical center of the lens and perpendicular to the optic axis. Radial distance may refer to a distance from a center of the lens, in some examples, a distance from the optical axis along a direction normal to the optical axis. In some examples, changing the height of at least one of the sections restraining the membrane may cause a change in the membrane's curvature, and the radial distance of the restraint may be changed to reduce increases in the membrane tension.

In some examples, a mechanical system may include a sliding mechanism, a rolling mechanism, a flexure mechanism, or an active mechanical system, or a combination thereof. In some examples, a mechanical system may include one or more actuators, and the one or more actuators may be configured to control both (or either of) the height and/or radial distance of one or more of the sections.

An adjustable focus fluid lens may include a substrate, a membrane that is in tension, a fluid, and a peripheral structure restraining the membrane tension, where the peripheral structure extends around a periphery of the membrane, and where, in some examples, the length of the peripheral structure and/or the spatial configuration of the peripheral structure may be controlled. Controlling the circumference of the membrane may controllably maintain the membrane tension when the optical power of the fluid lens is changed.

Changing the optical power of the lens from a first power to a second power may cause a first change in membrane tension if the membrane circumference does not change. However, changing the membrane circumference may allow a change in the membrane tension of approximately zero, or at least +/−1%, 2%, 3%, or 5%. In some examples, a load offset or a negative spring force may be applied to the actuator.

One or more components of a fluid lens may have strain energy within some or all operational configurations. In some examples, a fluid lens may include an elastomer membrane that may have strain energy if it is stretched. Work done by an external force, such as provided by an actuator when adjusting the membrane, may lead to an increase in the strain energy stored within the membrane. In some examples, one or more edge portions of the membrane are adjusted along a guide path such that the strain energy stored within the membrane may not be significantly changed, or changed by a reduced amount.

A force, such as a force provided by an actuator, may perform work when there is a displacement of the point of application in the direction of the force. In some examples, a fluid lens is configured so that there is no appreciable elastic force in the direction of the guide path. In such configurations, a displacement of the edge portion of the membrane along the guide path may not require work in relation to the elastic force. There may, however, be work required to overcome friction and other relatively minor effects.

In some examples, a fluid lens includes a support ring. A support ring may include a member affixed to a perimeter of a distensible membrane in a fluid-filled lens. The support ring may be approximately the same shape as the lens. For a circular lens, the support ring may be generally circular for spherical optics. For non-circular lenses, the support ring may bend normally to the plane defined by the membrane. However, a rigid support ring may impose restrictions on the positional adjustment of control points, and in some examples a wire is positioned around the periphery of the membrane. In some examples, a support ring may allow flexure out of the plane of the ring. In some examples, a support ring (or peripheral wire) may not be circular.

In some examples, a fluid lens may include one or more membranes. An example membrane may include a thin polymer film, having a membrane thickness much less than the lens radius, or other lateral extent of the lens. For example, the membrane thickness may be less than approximately 1 mm. The lateral extent of the lens may be at least approximately 10 mm. The membrane may provide the deformable optical surface of a fluid lens, such as an adjustable liquid-filled lens. A fluid lens may also include a substrate. The substrate may have opposite surfaces, and one surface of the substrate may provide one lens surface of an adaptable fluid-filled lens, opposite the lens surface provided by the membrane. An example substrate may include a rigid layer, such as a rigid polymer layer, or a rigid lens. In some examples, one or more actuators may be used to control the line tension of a distensible membrane, where line tension may be expressed in units of N/m. A substrate may include a rigid polymer, such as a rigid optical polymer. In some examples, a fluid lens may include an edge seal, for example, a deformable component, such as a polymer film, configured to retain the fluid in the lens. The edge seal may connect a peripheral portion of the membrane to a peripheral portion of the substrate, and may include a thin flexible polymer film.

In some examples, a membrane may include one or more control points. Control points may include locations proximate the periphery of the membrane, movement of that may be used to control one or more optical properties of a fluid lens. In some examples, the movement of the control point may be determined by the movement of a membrane attachment along a trajectory (or guide path) determined by a support structure. In some examples, a control point may be provided by an actuation point, for example, a location on a peripheral structure, such as a membrane attachment, that may have a position adjusted by an actuator. In some examples, an actuation point may have a position (e.g., relative to the substrate) controlled by a mechanical coupling to an actuator. A membrane attachment may mechanically interact with a support structure, and may be, for example, moveable along a trajectory (or guide path) determined by the support structure (e.g., by a slot or other guide structure). Control points may include locations within an edge portion of a membrane that may be moved, for example, using an actuator, or other mechanism. In some examples, an actuator may be used to move a membrane attachment (and, e.g., a corresponding control point) along a guide path provided by a support structure, for example, to adjust one or more optical properties of the fluid lens. In some examples, a membrane attachment may be hingedly connected to a support structure at one or more locations, optionally in addition to other types of connections. A hinged connection between the membrane and a support structure may be referred to as a hinge point.

A fluid lens may be configured to have one or both of the following features: in some examples, the strain energy in the membrane may be approximately equal for all actuation states; and in some examples, the force reaction at membrane edge may be approximately normal to the guide path. Hence, in some examples, the strain energy of the membrane may be approximately independent of the optical power of the lens. In some examples, the force reaction at the membrane edge is normal to the guide path, for some or all locations on the guide path.

In some examples, a guide path may be provided by a support structure including one or more of the following: a pivot, a flexure, a slide, a guide slot, a guide surface, a guide channel, a hinge, or other mechanism. A support structure may be entirely outside the fluid volume, entirely inside the fluid volume, or partially within the fluid volume.

In some examples, a fluid lens (that may also be termed a fluid-filled lens) may include a relatively rigid substrate and a flexible polymer membrane. The membrane may be attached to a support structure at control points around the membrane periphery. A flexible edge seal may be used to enclose the fluid. The lens power can be adjusted by moving the location of control points along guide trajectories, for example, using one more actuators. Guide paths (that may correspond to allowed trajectories of control points) may be determined that maintain a constant elastic deformation energy of the membrane as the control point location is moved along the guide path. Guide devices may be attached to (or formed as part of) the substrate.

Sources of elastic energy include hoop stress (tension in azimuth) and line strain, and elastic energy may be exchanged between these as the membrane is adjusted. In some examples, the force direction used to adjust the control point location may be normal to the elastic force on the support structure from the membrane. There are great possible advantages to this approach, including much reduced actuator size and power requirements, and a faster lens response that may be restricted only by viscous and friction effects.

In some examples, one or more optical parameters of a fluid lens may be determined at least in part by a physical profile of a membrane. In some examples, a fluid lens may be configured so that one or more optical parameters of the lens may be adjusted without significant change in the elastic strain energy in the membrane. For example, the elastic strain energy in the membrane may change by less than 20% as the lens is adjusted. In some examples, one or more optical parameters of the lens may be adjusted using an adjustment force, for example, a force applied by an actuator, that is normal to a direction of an elastic strain force in the membrane. In some examples, a guide path may be configured so that the adjustment force may be at least approximately normal to the elastic strain force during adjustment of the fluid lens. For example, the angle between the adjustment force and the elastic strain force may be within 5 degrees of normal, for example, within 3 degrees of normal.

In some examples, a fluid lens (that may also be termed a “fluid-filled lens”) includes a fluid, a substrate, and a membrane, with the substrate and the membrane at least partially enclosing the fluid. The fluid within a fluid lens may be referred to as a “lens fluid” or occasionally as a “fluid” for conciseness. The lens fluid may include a liquid, such as an oil, such as a silicone oil, such as a phenylated silicone oil.

In some examples, a lens fluid may be (or include) a transparent fluid. In this context, a transparent fluid may have little or substantially no visually perceptible visible wavelength absorption over an operational wavelength range. However, fluid lenses may also be used in the UV (ultraviolet) and the IR (infrared), and in some examples the fluid used may be generally non-absorbing in the wavelength range of the desired application, and may not be transparent over some or all of the visible wavelength range. In some examples, the membrane may be transparent, for example, optically clear at visible wavelengths.

In some examples, a lens fluid may include an oil, such as an optical oil. In some examples, a lens fluid may include one or more of a silicone, a thiol, or a cyano compound. The fluid may include a silicone based fluid, that may sometimes be referred to as a silicone oil. Example lens fluids include aromatic silicones, such as phenylated siloxanes, for example, pentaphenyl trimethyl trisiloxane. Example lens fluids may include a phenyl ether or phenyl thioether. Example lens fluids may include molecules including a plurality of aromatic rings, such as a polyphenyl compound (e.g., a polyphenyl ether or a polyphenyl thioether).

In some examples, a fluid lens includes, for example, a membrane at least partially enclosing a fluid. A fluid may be, or include, one or more of the following: a gas, gel, liquid, suspension, emulsion, vesicle, micelle, colloid, liquid crystal, or other flowable or otherwise deformable phase.

In some examples, a lens fluid may have a visually perceptible color or absorption, for example, for eye protection use or improvement in visual acuity. In some examples, the lens fluid may have a UV absorbing dye and/or a blue absorbing dye, and the fluid lens may have a slightly yellowish tint. In some examples, a lens fluid may include a dye selected to absorb specific wavelengths, for example, laser wavelengths in the example of laser goggles. In some examples, a device including a fluid lens may be configured as sunglasses, and the lens fluid may include an optical absorber and/or photochromic material. In some examples, a fluid lens may include a separate layer, such as a light absorption layer configured to reduce the light intensity passed to the eye, or protect the eye against specific wavelengths or wavelength bands. Reduced bubble formation may greatly enhance the effectiveness of laser protection devices, by reducing scattering of the laser radiation, and reduction of low-absorption portions of the device.

A fluid lens may include a deformable element such as a polymer membrane, or other deformable element. A polymer membrane may be an elastomer polymer membrane. Membrane thicknesses may be in the range 1 micron-1 mm, such as between 3 microns-500 microns, for example, between 5 microns and 100 microns. An example membrane may be more of the following: flexible, optically transparent, water impermeable, and/or elastomeric. A membrane may include one or more elastomers, such as one or more thermoplastic elastomers. A membrane may include one or more polymers, such as one or more of the following: a polyurethane (such as a thermoplastic polyurethane (TPU), a thermoplastic aromatic polyurethane, an aromatic polyether polyurethane, and/or a cross-linked urethane polymer), a silicone elastomer such as a polydimethylsiloxane, a polyolefin, a polycycloaliphatic polymer, a polyether, a polyester (e.g., polyethylene terephthalate), a polyimide, a vinyl polymer (e.g., a polyvinylidene chloride), a polysulfone, a polythiourethane, polymers of cycloolefins and aliphatic or alicyclic polyethers, a fluoropolymer (e.g., polyvinylfluoride), another suitable polymer, and/or a blend, derivative, or analog of one or more such polymers. The membrane may be an elastomer membrane, and the membrane may include one or more elastomers.

In some examples, the coating may prevent the lens fluid, such as an optical oil, from penetrating the membrane, which may otherwise degrade the optical and/or physical properties of the membrane (e.g., by causing the membrane to become cloudy, swell, and/or to lose tension. In some examples, the coating may both appreciably reduce bubble formation, and appreciably reduce fluid diffusion into the membrane (e.g., by reducing the rate of fluid diffusion into the membrane by at least 50%, compared to an uncoated membrane under similar conditions).

In some examples, a fluid lens may include a substrate. The substrate may be relatively rigid, and may exhibit no visually perceptible deformation due to, for example, adjusting the internal pressure of the fluid and/or tension on the membrane. In some examples, the substrate may be a generally transparent planar sheet. The substrate may include one more substrate layers, and a substrate layer may include a polymer, glass, optical film, and the like. Example glasses include silicate glasses, such as borosilicate glasses. In some examples, a substrate may include one or more polymers, such as an acrylate polymer (e.g., polymethylmethacrylate), a polycarbonate, a polyurethane (such as an aromatic polyurethane), or other suitable polymer. In some examples, one or both surfaces of a substrate may be planar, spherical, cylindrical, spherocylindrical, convex, concave, parabolic, or have a freeform surface curvature. One or both surfaces of a substrate may approximate a prescription of a user, and adjustment of the membrane profile (e.g., by adjustment of the membrane curvature) may be used to provide an improved prescription, for example, for reading, distance viewing, or other use. In some examples, the substrate may have no significant optical power, for example, by having parallel planar surfaces.

Membrane deformation may be used to adjust an optical parameter, such as a focal length, around a center value determined by relatively fixed surface curvature(s) of a substrate or other optical element, for example, of one or both surfaces of a substrate.

In some examples, the substrate may include an elastomer, and may in some examples have an adjustable profile (that may have a smaller range of adjustments than provided by the membrane), and in some examples the substrate may be omitted and the fluid enclosed by a pair of membranes or other flexible enclosure configuration.

In some examples, a fluid lens may include one or more actuators. The one or more actuators may be used to modify the elastic tension of a membrane, and may hence modify an optical parameter of a fluid lens including the membrane. The membrane may be connected to a substrate around the periphery of the membrane, for example, using a connection assembly. The connection assembly may include one or more of an actuator, a post, a wire, or other connection hardware. In some examples, one or more actuators are used to adjust the curvature of the membrane, and hence the optical properties of the fluid lens.

In some examples, a device including a fluid lens may include a one or more fluid lenses supported by a frame, such as ophthalmic glasses, goggles, visors, and the like.

Applications of the concepts described herein include fluid lenses, and devices that may include one or more fluid lenses, such as ophthalmic devices (e.g., glasses), augmented reality devices, virtual reality devices, and the like. Fluid lenses may be incorporated into eyewear, such as wearable optical devices like eyeglasses, an augmented reality or virtual reality headset, and/or other wearable optical device. Due to these principles described herein, these devices may exhibit reduced thickness, reduced weight, improved wide-angle/field-of-view optics (e.g., for a given weight), and/or improved aesthetics. Examples include devices including one or more lenses shaped and sized for use in glasses, head-up displays, augmented reality devices, virtual reality devices, and the like. In some examples, the fluid lenses may be the primary viewing lenses for the device, for example, lenses through which light from the environment passes before reaching the eye of a user. In some examples, a fluid lens may have a diameter or other analogous dimension (e.g., width or height of a non-circular lens) that is between 20 mm and 80 mm.

As mentioned above, the fluid lenses described herein may be used to correct for VAC, that may refer to, for example, user discomfort while using an augmented reality or virtual reality device. VAC may be caused by the focal plane of virtual content (related to eye accommodation) not matching the virtual content's apparent distance based on stereoscopy (related to eye vergence).

In some examples, similar approaches may be used to reduce gas diffusion through a fluid lens membrane, such as through a membrane including a polymer film. In some examples, similar approaches may be used to reduce or substantially prevent fluid diffusion into a fluid lens component, such as a membrane and/or substrate.

In some examples, a device may include a fluid lens, which may also be referred to more simply as a lens for conciseness. The lens may include a membrane, a substrate (such as a rigid substrate, where one or both of the substrate surfaces may be planar or curved), and a fluid located within an enclosure formed at least in part by the membrane and the substrate. For example, the enclosure may be formed by the membrane, an edge seal, and a substrate. A coating may be disposed on at least a portion of the interior surface of the enclosure. The coating may have a coating surface adjacent the fluid. The membrane may be an elastic membrane. The coating and the membrane may have different compositions. The coating may significantly reduce bubble formation within the fluid. For example, bubble formation may be substantially eliminated, for example, when the fluid is under negative pressure. The lens may further include a support structure configured to retain the membrane under tension, which may be attached to the substrate. An optical property of the lens may be adjusted by adjusting a membrane profile, such as a curvature (e.g., a radius of curvature) of the membrane. The optical property may an optical power of the fluid lens, and the optical power may be adjustable to a negative value. The membrane may have a membrane profile, which may have a membrane curvature, and the membrane curvature may be adjustable to a negative value. A negative value of membrane curvature may correspond to a negative radius of curvature of the exterior surface of the membrane, and may correspond to a concave lens exterior surface. For a negative surface, the center of curvature may be on the opposite side of the negative surface from the center of the lens (e.g., outside the exterior of the surface). The center of a negative surface may be closer to the center of the lens than the periphery, so the lens may be thinner within a central portion and thicker around the periphery. The substrate may be a rigid substrate. The coating surface may have a coating surface roughness, the interior surface of the enclosure (e.g., the at least a portion of the interior surface on which the coating is located) may have an enclosure surface roughness, and the coating surface roughness may be significantly less than the enclosure surface roughness.

In some examples, a fluid lens (e.g., a liquid lens) includes a substrate, a flexible membrane, and a fluid located with an enclosure formed between the substrate and the membrane. In conventional lenses, bubble formation within the lens fluid may reduce optical quality and aesthetics of the lens. In some cases, reduced pressure may be applied (e.g., to obtain a concave lens surface) and this may induce bubble formation on the inside surfaces of the substrate and membrane. Bubble formation may degrade the optical performance and/or appearance of the lens, but may be reduced or substantially prevented using one or more approaches such as those described herein. The coating may significantly reduce bubble formation within the fluid, for example, when a negative pressure is applied to the fluid. Ophthalmic applications of the concepts described herein include spectacles with a flat or curved front substrate and an adjustable eye-side concave, planar, or convex membrane surface. Applications also include optics, and other applications of fluid lenses, including augmented reality or virtual reality headsets.

### EXAMPLE EMBODIMENTS

Example 1. A device may include a fluid lens, where the fluid lens includes: a membrane; a substrate; a fluid located within an enclosure formed at least in part by the membrane and the substrate, the enclosure having an enclosure surface; and a coating disposed on at least a portion of the enclosure surface, the coating having a coating surface adjacent the fluid, where: the membrane is an elastic membrane; the coating and the membrane have different compositions; and the coating significantly reduces bubble formation within the fluid.

Example 2. The device of example 1, where the membrane has a membrane curvature, and the fluid lens further includes a support structure configured to: retain the membrane under tension; and allow adjustment of the membrane curvature to modify an optical property of the fluid lens.

Example 3. The device of any of examples 1-2, where the membrane curvature is adjustable to a negative membrane curvature.

Example 4. The device of example 2, where the optical property is an optical power of the fluid lens, and the optical power is adjustable to a negative value.

Example 5. The device of any of examples 1-4, where the substrate is a rigid substrate, and the coating is deposited directly on the substrate surface.

Example 6. The device of any of examples 1-5, where: the coating surface has a coating surface roughness; the enclosure surface has an enclosure surface roughness; and the coating surface roughness is significantly less than the enclosure surface roughness.

Example 7. The device of any of examples 1-6, where the coating includes a polymer.

Example 8. The device of any of examples 1-7, where the polymer includes at least one of an acrylate polymer, a silicone polymer, an epoxy polymer, or a urethane polymer.

Example 9. The device of any of examples 1-8, where the coating includes a fluoropolymer.

Example 10. The device of any of examples 1-9, where the device includes a frame, the frame enclosing the fluid lens.

Example 11. The device of any of examples 1-10, where the device is a head-mounted device.

Example 12. The device of any of examples 1-11, where the device is an ophthalmic device configured to be used as eyewear.

Example 13. The device of any of examples 1-12, where the fluid is a liquid, the device is an adjustable liquid lens, and the coating significantly reduces gas bubble formation within the liquid.

Example 14. The device of any of examples 1-13, where the fluid includes a silicone oil.

Example 15. A method may include: assembling a fluid lens assembly including a substrate and an elastic membrane, the fluid lens assembly having an enclosure at least partially enclosed by the substrate and the elastic membrane, the enclosure having an interior surface; forming a coating on at least a portion of the interior surface of the enclosure; and introducing a lens fluid into the enclosure to form a fluid lens, where the coating is configured to reduce bubble formation within the lens fluid during operation of the fluid lens.

Example 16. The method of example 15, where forming the coating includes: introducing a coating material into the enclosure; and depositing the coating material onto the interior surface.

Example 17. The method of any of examples 15-16, where depositing the coating material onto the interior surface includes ultrasonic agitation of the fluid lens assembly.

Example 18. The method of any of examples 15-17, where the coating material is introduced into the enclosure before introducing the lens fluid into the enclosure.

Example 19. The method of any of examples 15-18, further including polymerizing the coating material to form the coating on the interior surface.

Example 20. The method of any of examples 15-19, where the method is a method of fabricating an ophthalmic device including the fluid lens.

Embodiments of the present disclosure may include or be implemented in conjunction with various types of artificial reality systems. Artificial reality is a form of reality that has been adjusted in some manner before presentation to a user, that may include, for example, a virtual reality, an augmented reality, a mixed reality, a hybrid reality, or some combination and/or derivative thereof. Artificial-reality content may include completely generated content or generated content combined with captured (e.g., real-world) content. The artificial-reality content may include video, audio, haptic feedback, or some combination thereof, any of that may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

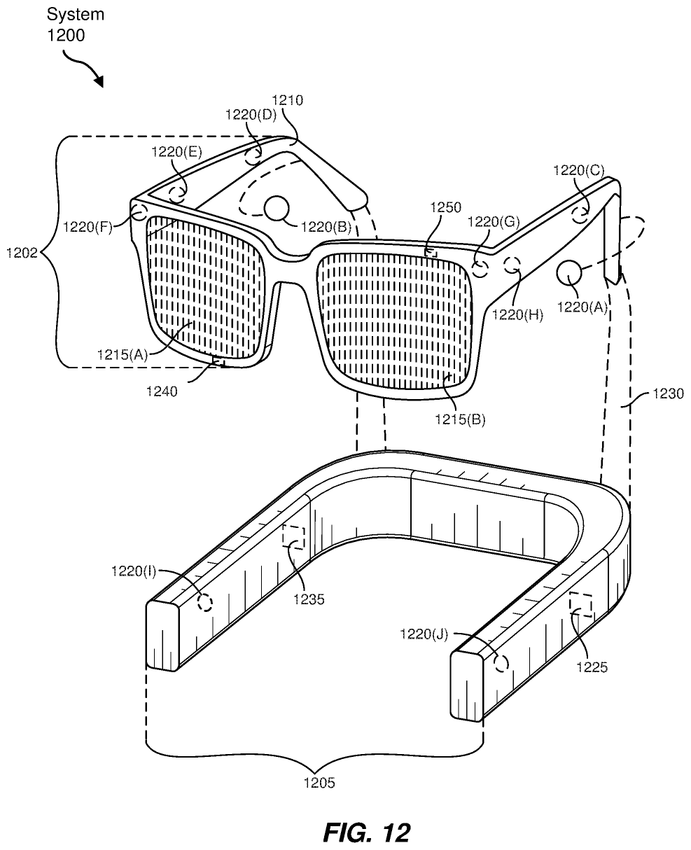

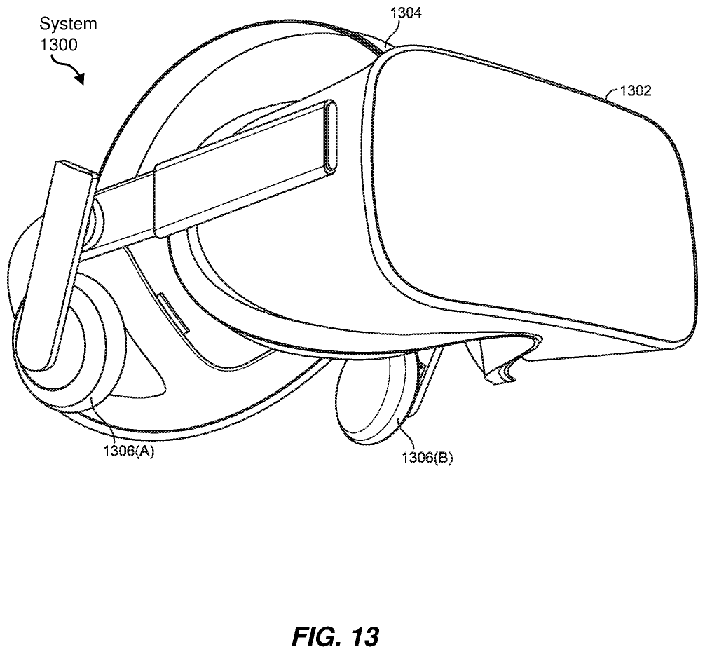

Artificial-reality systems may be implemented in a variety of different form factors and configurations. Some artificial reality systems may be designed to work without near-eye displays (NEDs), an example of which is augmented-reality system 1100 in FIG. 11. Other artificial reality systems may include a NED that also provides visibility into the real world (e.g., augmented-reality system 1200 in FIG. 12) or that visually immerses a user in an artificial reality (e.g., virtual-reality system 1300 in FIG. 13). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 11, augmented-reality system 1100 generally represents a wearable device dimensioned to fit about a body part (e.g., a head) of a user. As shown in FIG. 11, augmented-reality system 1100 may include a frame 1102 and a camera assembly 1104 that is coupled to frame 1102 and configured to gather information about a local environment by observing the local environment. Augmented-reality system 1100 may also include one or more audio devices, such as output audio transducers 1108(A) and 1108(B) and input audio transducers 1110. Output audio transducers 1108(A) and 1108(B) may provide audio feedback and/or content to a user, and input audio transducers 1110 may capture audio in a user's environment.

As shown, augmented-reality system 1100 may not necessarily include a NED positioned in front of a user's eyes. Augmented-reality systems without NEDs may take a variety of forms, such as head bands, hats, hair bands, belts, watches, wrist bands, ankle bands, rings, neckbands, necklaces, chest bands, eyewear frames, and/or any other suitable type or form of apparatus. While augmented-reality system 1100 may not include a NED, augmented-reality system 1100 may include other types of screens or visual feedback devices (e.g., a display screen integrated into a side of frame 1102).

Example embodiments discussed in this disclosure may be implemented in augmented-reality systems that include one or more NEDs. For example, as shown in FIG. 12, augmented-reality system 1200 may include eyewear device 1202 with frame 1210 configured to hold left display device 1215(A) and right display device 1215(B) in front of a user's eyes. Display devices 1215(A) and 1215(B) may act together or independently to present an image or series of images to a user. While augmented-reality system 1200 includes two displays, embodiments of this disclosure may be implemented in augmented-reality systems with a single NED or more than two NEDs.

In some embodiments, augmented-reality system 1200 may include one or more sensors, such as sensor 1240. Sensor 1240 may generate measurement signals in response to motion of augmented-reality system 1200 and may be located on substantially any portion of frame 1210. Sensor 1240 may represent a position sensor, an inertial measurement unit (IMU), a depth camera assembly, or any combination thereof. In some embodiments, augmented-reality system 1200 may or may not include sensor 1240 or may include more than one sensor. In embodiments in which sensor 1240 includes an IMU, the IMU may generate calibration data based on measurement signals from sensor 1240. Examples of sensor 1240 may include, without limitation, accelerometers, gyroscopes, magnetometers, other suitable types of sensors that detect motion, sensors used for error correction of the IMU, or some combination thereof.

Augmented-reality system 1200 may also include a microphone array with a plurality of acoustic transducers 1220(A)-1220(J), referred to collectively as acoustic transducers 1220. Acoustic transducers 1220 may be transducers that detect air pressure variations induced by sound waves. Each acoustic transducer 1220 may be configured to detect sound and convert the detected sound into an electronic format (e.g., an analog or digital format). The microphone array in FIG. 2 may include, for example, ten acoustic transducers: 1220(A) and 1220(B), that may be designed to be placed inside a corresponding ear of the user, acoustic transducers 1220(C), 1220(D), 1220(E), 1220(F), 1220(G), and 1220(H), that may be positioned at various locations on frame 1210, and/or acoustic transducers 1220(I) and 1220(J), that may be positioned on the neckband 1205.

In some embodiments, one or more of acoustic transducers 1220(A)-(F) may be used as output transducers (e.g., speakers). For example, acoustic transducers 1220(A) and/or 1220(B) may be earbuds or any other suitable type of headphone or speaker.

The configuration of acoustic transducers 1220 of the microphone array may vary. While augmented-reality system 1200 is shown in FIG. 12 as having ten acoustic transducers 1220, the number of acoustic transducers 1220 may be greater or less than ten. In some embodiments, using higher numbers of acoustic transducers 1220 may increase the amount of audio information collected and/or the sensitivity and accuracy of the audio information. In contrast, using a lower number of acoustic transducers 1220 may decrease the computing power required by the controller 1250 to process the collected audio information. In addition, the position of each acoustic transducer 1220 of the microphone array may vary. For example, the position of an acoustic transducer 1220 may include a defined position on the user, a defined coordinate on frame 1210, an orientation associated with each acoustic transducer, or some combination thereof.

Acoustic transducers 1220(A) and 1220(B) may be positioned on different parts of the user's ear, such as behind the pinna or within the auricle or fossa. Or, there may be additional acoustic transducers on or surrounding the ear in addition to acoustic transducers 1220 inside the ear canal. Having an acoustic transducer positioned next to an ear canal of a user may enable the microphone array to collect information on how sounds arrive at the ear canal. By positioning at least two of acoustic transducers 1220 on either side of a user's head (e.g., as binaural microphones), augmented-reality system 1200 may simulate binaural hearing and capture a 3D stereo sound field around about a user's head. In some embodiments, acoustic transducers 1220(A) and 1220(B) may be connected to augmented-reality system 1200 via a wired connection 1230, and in other embodiments, acoustic transducers 1220(A) and 1220(B) may be connected to augmented-reality system 1200 via a wireless connection (e.g., a Bluetooth connection). In some embodiments, acoustic transducers 1220(A) and 1220(B) may omitted, for example, in conjunction with augmented-reality system 1200.

Acoustic transducers 1220 on frame 1210 may be positioned along the length of the temples, across the bridge, above or below display devices 1215(A) and 1215(B), or some combination thereof. Acoustic transducers 1220 may be oriented such that the microphone array is able to detect sounds in a wide range of directions surrounding the user wearing the augmented-reality system 1200. In some embodiments, an optimization process may be performed during manufacturing of augmented-reality system 1200 to determine relative positioning of each acoustic transducer 1220 in the microphone array.

In some examples, augmented-reality system 1200 may include or be connected to an external device (e.g., a paired device), such as neckband 1205. Neckband 1205 generally represents any type or form of paired device. Thus, the discussion of neckband 1205 may also apply to various other paired devices, such as charging cases, smart watches, smart phones, wrist bands, other wearable devices, hand-held controllers, tablet computers, laptop computers and other external compute devices, etc.

As shown, neckband 1205 may be coupled to eyewear device 1202 via one or more connectors. The connectors may be wired or wireless and may include electrical and/or non-electrical (e.g., structural) components. In some cases, eyewear device 1202 and neckband 1205 may operate independently without any wired or wireless connection between them. While FIG. 12 illustrates the components of eyewear device 1202 and neckband 1205 in example locations on eyewear device 1202 and neckband 1205, the components may be located elsewhere and/or distributed differently on eyewear device 1202 and/or neckband 1205. In some embodiments, the components of eyewear device 1202 and neckband 1205 may be located on one or more additional peripheral devices paired with eyewear device 1202, neckband 1205, or some combination thereof. Furthermore,

Pairing external devices, such as neckband 1205, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1200 may be provided by a paired device or shared between a paired device and an eyewear device, thus reducing the weight, heat profile, and form factor of the eyewear device overall while still retaining desired functionality. For example, neckband 1205 may allow components that would otherwise be included on an eyewear device to be included in neckband 1205 since users may tolerate a heavier weight load on their shoulders than they would tolerate on their heads. Neckband 1205 may also have a larger surface area over which to diffuse and disperse heat to the ambient environment. Thus, neckband 1205 may allow for greater battery and computation capacity than might otherwise have been possible on a stand-alone eyewear device. Since weight carried in neckband 1205 may be less invasive to a user than weight carried in eyewear device 1202, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 1205 may be communicatively coupled with eyewear device 1202 and/or to other devices. These other devices may provide certain functions (e.g., tracking, localizing, depth mapping, processing, storage, etc.) to augmented-reality system 1200. In the embodiment of FIG. 12, neckband 1205 may include two acoustic transducers (e.g., 1220(I) and 1220(J)) that are part of the microphone array (or potentially form their own microphone subarray). Neckband 1205 may also include a controller 1225 and a power source 1235.

Acoustic transducers 1220(I) and 1220(J) of neckband 1205 may be configured to detect sound and convert the detected sound into an electronic format (analog or digital). In the embodiment of FIG. 12, acoustic transducers 1220(I) and 1220(J) may be positioned on neckband 1205, thereby increasing the distance between the neckband acoustic transducers 1220(I) and 1220(J) and other acoustic transducers 1220 positioned on eyewear device 1202. In some cases, increasing the distance between acoustic transducers 1220 of the microphone array may improve the accuracy of beamforming performed via the microphone array. For example, if a sound is detected by acoustic transducers 1220(C) and 1220(D) and the distance between acoustic transducers 1220(C) and 1220(D) is greater than, for example, the distance between acoustic transducers 1220(D) and 1220(E), the determined source location of the detected sound may be more accurate than if the sound had been detected by acoustic transducers 1220(D) and 1220(E).

Controller 1225 of neckband 1205 may process information generated by the sensors on 1205 and/or augmented-reality system 1200. For example, controller 1225 may process information from the microphone array that describes sounds detected by the microphone array. For each detected sound, controller 1225 may perform a direction-of-arrival (DOA) estimation to estimate a direction from which the detected sound arrived at the microphone array. As the microphone array detects sounds, controller 1225 may populate an audio data set with the information. In embodiments in which augmented-reality system 1200 includes an inertial measurement unit, controller 1225 may compute inertial and spatial calculations from the IMU located on eyewear device 1202. A connector may convey information between augmented-reality system 1200 and neckband 1205 and between augmented-reality system 1200 and controller 1225. The information may be in the form of optical data, electrical data, wireless data, or any other transmittable data form. Moving the processing of information generated by augmented-reality system 1200 to neckband 1205 may reduce weight and heat in eyewear device 1202, making it more comfortable to the user.

Power source 1235 in neckband 1205 may provide power to eyewear device 1202 and/or to neckband 1205. Power source 1235 may include, without limitation, lithium ion batteries, lithium-polymer batteries, primary lithium batteries, alkaline batteries, or any other form of power storage. In some cases, power source 1235 may be a wired power source. Including power source 1235 on neckband 1205 instead of on eyewear device 1202 may help better distribute the weight and heat generated by power source 1235.

As noted, some artificial reality systems may, instead of blending an artificial reality with actual reality, substantially replace one or more of a user's sensory perceptions of the real world with a virtual experience. One example of this type of system is a head-mounted device such as a head-worn display system, such as virtual-reality system 1300 in FIG. 13, that may mostly or completely cover a user's field of view. Virtual-reality system 1300 may include a front rigid body 1302 and a band 1304 shaped to fit around a user's head. Virtual-reality system 1300 may also include output audio transducers 1306(A) and 1306(B). Furthermore, while not shown in FIG. 13, front rigid body 1302 may include one or more electronic elements, including one or more electronic displays, one or more inertial measurement units (IMUs), one or more tracking emitters or detectors, and/or any other suitable device or system for creating an artificial reality experience.

Artificial reality systems may include a variety of types of visual feedback mechanisms. For example, display devices in augmented-reality system 1200 and/or virtual-reality system 1300 may include one or more liquid crystal displays (LCDs), light emitting diode (LED) displays, organic LED (OLED) displays, and/or any other suitable type of display screen. Artificial reality systems may include a single display screen for both eyes or may provide a display screen for each eye, that may allow for additional flexibility for varifocal adjustments or for correcting a user's refractive error. Some artificial reality systems may also include optical subsystems having one or more lenses (e.g., conventional concave or convex lenses, Fresnel lenses, adjustable liquid lenses, etc.) through which a user may view a display screen.

In addition to or instead of using display screens, some artificial reality systems may include one or more projection systems. For example, display devices in augmented-reality system 1200 and/or virtual-reality system 1300 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. Artificial reality systems may also be configured with any other suitable type or form of image projection system.

Artificial reality systems may also include various types of computer vision components and subsystems. For example, augmented-reality system 1100, augmented-reality system 1200, and/or virtual-reality system 1300 may include one or more optical sensors, such as two-dimensional (2D) or three-dimensional (3D) cameras, time-of-flight depth sensors, single-beam or sweeping laser rangefinders, 3D LiDAR sensors (e.g., light detection and ranging sensors), and/or any other suitable type or form of optical sensor. An artificial reality system may process data from one or more of these sensors to identify a location of a user, to map the real world, to provide a user with context about real-world surroundings, and/or to perform a variety of other functions.

Artificial reality systems may also include one or more input and/or output audio transducers. In the examples shown in FIGS. 11 and 13, output audio transducers 1108(A), 1108(B), 1306(A), and 1306(B) may include voice coil speakers, ribbon speakers, electrostatic speakers, piezoelectric speakers, bone conduction transducers, cartilage conduction transducers, and/or any other suitable type or form of audio transducer. Similarly, input audio transducers 1110 may include condenser microphones, dynamic microphones, ribbon microphones, and/or any other type or form of input transducer. In some embodiments, a single transducer may be used for both audio input and audio output.

While not shown in FIGS. 11-13, artificial reality systems may include tactile (i.e., haptic) feedback systems, that may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visuals aids, etc.). The embodiments disclosed herein may enable or enhance a user's artificial reality experience in one or more of these contexts and environments and/or in other contexts and environments.

As noted, the artificial reality systems described herein may be used with a variety of other types of devices to provide a more compelling artificial reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, that may also be referred to as cutaneous feedback) and/or kinesthetic feedback (e.g., feedback that a user detects via receptors located in muscles, joints, and/or tendons).

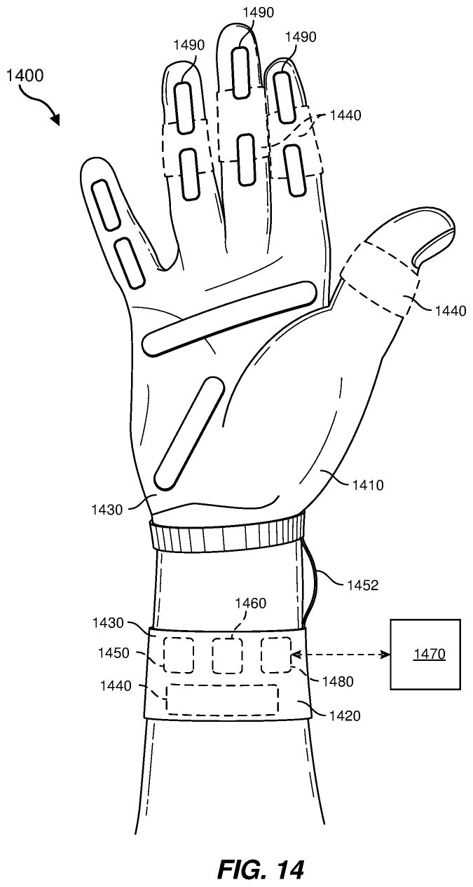

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 14 illustrates a vibrotactile system 1400 in the form of a haptic device 1410 (that may be or include a wearable glove) and haptic device 1420 (that may be or include a wristband). Haptic device 1410 and haptic device 1420 are shown as examples of wearable devices that include a textile material 1430, that may be flexible and/or wearable and that may be shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1440 may be positioned at least partially within one or more corresponding pockets formed in textile material 1430 of vibrotactile system 1400. Vibrotactile devices 1440 may be positioned in locations to provide a vibrating sensation (e.g., haptic feedback) to a user of vibrotactile system 1400. For example, vibrotactile devices 1440 may be positioned to be against the user's finger(s), thumb, or wrist, as shown in FIG. 14. Vibrotactile devices 1440 may, in some examples, be sufficiently flexible to conform to or bend with the user's corresponding body part(s).

A power source 1450 (e.g., a battery) for applying a voltage to the vibrotactile devices 1440 for activation thereof may be electrically coupled to vibrotactile devices 1440, such as via conductive wiring 1452. In some examples, each of vibrotactile devices 1440 may be independently electrically coupled to power source 1450 for individual activation. In some embodiments, a processor 1460 may be operatively coupled to power source 1450 and configured (e.g., programmed) to control activation of vibrotactile devices 1440.

Vibrotactile system 1400 may be implemented in a variety of ways. In some examples, vibrotactile system 1400 may be a standalone system with integral subsystems and components for operation independent of other devices and systems. As another example, vibrotactile system 1400 may be configured for interaction with another device or system 1470. For example, vibrotactile system 1400 may, in some examples, include a communications interface 1480 for receiving and/or sending signals to the other device or system 1470. The other device or system 1470 may be a mobile device, a gaming console, an artificial reality (e.g., virtual reality, augmented reality, mixed reality) device, a personal computer, a tablet computer, a network device (e.g., a modem, a router, etc.), a handheld controller, etc. Communications interface 1480 may enable communications between vibrotactile system 1400 and the other device or system 1470 via a wireless (e.g., Wi-Fi, Bluetooth, cellular, radio, etc.) link or a wired link. If present, communications interface 1480 may be in communication with processor 1460, such as to provide a signal to processor 1460 to activate or deactivate one or more of the vibrotactile devices 1440.

Vibrotactile system 1400 may optionally include other subsystems and components, such as touch-sensitive pads 1490, pressure sensors, motion sensors, position sensors, lighting elements, and/or user interface elements (e.g., an on/off button, a vibration control element, etc.). During use, vibrotactile devices 1440 may be configured to be activated for a variety of different reasons, such as in response to the user's interaction with user interface elements, a signal from the motion or position sensors, a signal from the touch-sensitive pads 1490, a signal from the pressure sensors, a signal from the other device or system 1470, etc.

Although power source 1450, processor 1460, and communications interface 1480 are illustrated in FIG. 14 as being positioned in haptic device 1420, this is optional. For example, one or more of power source 1450, processor 1460, or communications interface 1480 may be positioned within haptic device 1410 or within another wearable textile.

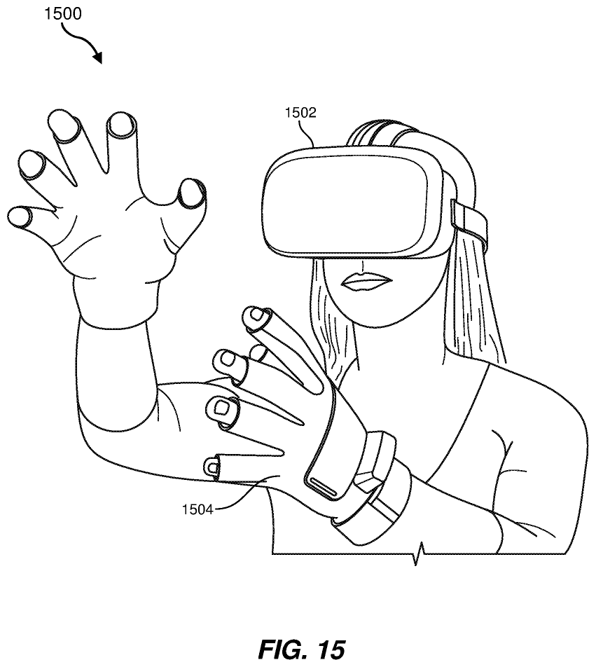

Haptic wearables, such as those shown in and described in connection with FIG. 14, may be implemented in a variety of types of artificial-reality systems and environments. FIG. 15 shows an example artificial reality environment 1500 including one head-mounted virtual-reality display and two haptic devices (i.e., gloves), and in other embodiments any number and/or combination of these components and other components may be included in an artificial reality system. For example, in some embodiments there may be multiple head-mounted displays each having an associated haptic device, with each head-mounted display and each haptic device communicating with the same console, portable computing device, or other computing system.

Head-mounted display 1502 generally represents any type or form of virtual-reality system, such as virtual-reality system 1300 in FIG. 13. Haptic device 1504 generally represents any type or form of wearable device, worn by a use of an artificial reality system, that provides haptic feedback to the user to give the user the perception that he or she is physically engaging with a virtual object. In some embodiments, haptic device 1504 may provide haptic feedback by applying vibration, motion, and/or force to the user. For example, haptic device 1504 may limit or augment a user's movement. To give a specific example, haptic device 1504 may limit a user's hand from moving forward so that the user has the perception that his or her hand has come in physical contact with a virtual wall. In this specific example, one or more actuators within the haptic advice may achieve the physical-movement restriction by pumping fluid into an inflatable bladder of the haptic device. In some examples, a user may also use haptic device 1504 to send action requests to a console. Examples of action requests include, without limitation, requests to start an application and/or end the application and/or requests to perform a particular action within the application.

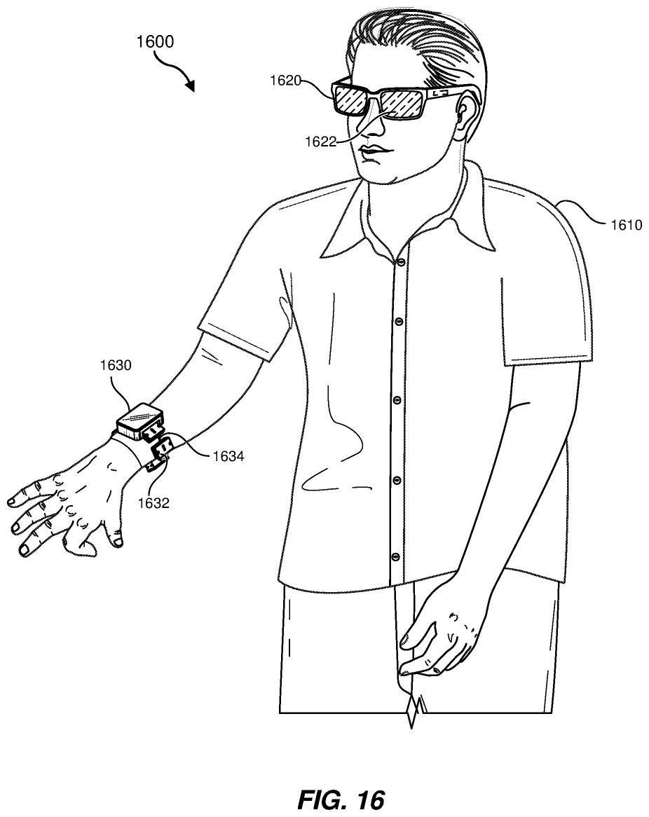

While haptic interfaces may be used with virtual-reality systems, as shown in FIG. 15, haptic interfaces may also be used with augmented-reality systems, as shown in FIG. 16. FIG. 16 is a perspective view a user 1610 interacting with an augmented-reality system 1600. In this example, user 1610 may wear a pair of augmented-reality glasses 1620 that have one or more displays 1622 and that are paired with a haptic device 1630. Haptic device 1630 may be a wristband that includes a plurality of band elements 1632 and a tensioning mechanism 1634 that connects band elements 1632 to one another.

One or more of band elements 1632 may include any type or form of actuator suitable for providing haptic feedback. For example, one or more of band elements 1632 may be configured to provide one or more of various types of cutaneous feedback, including vibration, force, traction, texture, and/or temperature. To provide such feedback, band elements 1632 may include one or more of various types of actuators. In one example, each of band elements 1632 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1410, 1420, 1504, and 1630 may include any suitable number and/or type of haptic transducer, sensor, and/or feedback mechanism. For example, haptic devices 1410, 1420, 1504, and 1630 may include one or more mechanical transducers, piezoelectric transducers, and/or fluidic transducers. Haptic devices 1410, 1420, 1504, and 1630 may also include various combinations of different types and forms of transducers that work together or independently to enhance a user's artificial-reality experience. In one example, each of band elements 1632 of haptic device 1630 may include a vibrotactor (e.g., a vibrotactile actuator) configured to vibrate in unison or independently to provide one or more of various types of haptic sensations to a user.

The present disclosure may anticipate or include various methods, such as computer-implemented methods. Method steps may be performed by any suitable computer-executable code and/or computing system, and may be performed by the control system of a virtual and/or augmented reality system. Each of the steps of example methods may represent an algorithm whose structure may include and/or may be represented by multiple sub-steps.

In some examples, a system according to the present disclosure may include at least one physical processor and physical memory including computer-executable instructions that, when executed by the physical processor, cause the physical processor to adjust the optical properties of a fluid lens substantially as described herein.

In some examples, a non-transitory computer-readable medium according to the present disclosure may include one or more computer-executable instructions that, when executed by at least one processor of a computing device, cause the computing device to adjust the optical properties of a fluid lens substantially as described herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed, transform the data, output a result of the transformation to perform a function, use the result of the transformation to perform a function, and store the result of the transformation to perform a function. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device including a fluid lens, wherein the fluid lens comprises:
a membrane;
a substrate;
a fluid located within an enclosure formed at least in part by the membrane and the substrate, the enclosure having an enclosure surface; and
a coating disposed on at least a portion of the enclosure surface, the coating having a coating surface adjacent the fluid,
wherein:
the membrane is an elastic membrane;
the coating and the membrane have different compositions; and
the coating significantly reduces bubble formation within the fluid.

2. The device of claim 1, wherein the membrane has a membrane curvature, and the fluid lens further includes a support structure configured to:
retain the membrane under tension; and
allow adjustment of the membrane curvature to modify an optical property of the fluid lens.

3. The device of claim 2, wherein the membrane curvature is adjustable to a negative value.

4. The device of claim 2, wherein the optical property is an optical power of the fluid lens, and the optical power is adjustable to a negative value.

5. The device of claim 1, wherein the substrate is a rigid substrate, and the coating is deposited directly on the enclosure surface.

6. The device of claim 1, wherein:
the coating surface has a coating surface roughness;
the enclosure surface has an enclosure surface roughness; and
the coating surface roughness is significantly less than the enclosure surface roughness.

7. The device of claim 1, wherein the coating includes a polymer.

8. The device of claim 7, wherein the polymer includes at least one of an acrylate polymer, a silicone polymer, an epoxy polymer, or a urethane polymer.

9. The device of claim 7, wherein the coating comprises a fluoropolymer.

10. The device of claim 1, wherein the device includes a frame, the frame enclosing the fluid lens.

11. The device of claim 1, wherein the device is a head-mounted device.

12. The device of claim 11, wherein the device is an ophthalmic device configured to be used as eyewear.

13. The device of claim 1, wherein the fluid is a liquid, the device is an adjustable liquid lens, and the coating significantly reduces gas bubble formation within the liquid.

14. The device of claim 13, wherein the liquid includes a silicone oil.

15. A method, comprising:
assembling a fluid lens assembly including a substrate and an elastic membrane, the fluid lens assembly having an enclosure at least partially enclosed by the substrate and the elastic membrane, the enclosure having an interior surface;
forming a coating on at least a portion of the interior surface of the enclosure; and
introducing a lens fluid into the enclosure to form a fluid lens,
wherein the coating is configured to reduce bubble formation within the lens fluid during operation of the fluid lens.

16. The method of claim 15, wherein forming the coating includes:
introducing a coating material into the enclosure; and
depositing the coating material onto the interior surface.

17. The method of claim 16, wherein depositing the coating material onto the interior surface includes ultrasonic agitation of the fluid lens assembly.

18. The method of claim 16, wherein the coating material is introduced into the enclosure before introducing the lens fluid into the enclosure.

19. The method of claim 16, further including polymerizing the coating material to form the coating on the interior surface.

20. The method of claim 15, wherein the method is a method of fabricating an ophthalmic device including the fluid lens.
